(19) United States
(12) Patent Application Publication
(10) Pub. No.: US 2025/0065650 A1
(43) Pub. Date: Feb. 27, 2025

(54) RECORDING APPARATUS

(71) Applicant: SEIKO EPSON CORPORATION, Tokyo (JP)

(72) Inventors: Hidefumi MINEMURA, SHIOJIRI-SHI (JP); Keisuke SASAKI, MATSUMOTO-SHI (JP); Kenichi FURUYA, SHIOJIRI-SHI (JP); Toshio MIYAKE, SHIOJIRI-SHI (JP)

(21) Appl. No.: 18/812,768

(22) Filed: Aug. 22, 2024

(30) Foreign Application Priority Data
Aug. 23, 2023 (JP) 2023-135576
Feb. 1, 2024 (JP) 2024-014213

(51) Int. Cl. B41J 13/10; B41J 13/03; B41J 25/00; B65H 29/22

(52) U.S. Cl. CPC B41J 13/106; B41J 13/03; B41J 25/001; B65H 29/22; B65H 2403/40; B65H 2403/725; B65H 2404/16

(57) ABSTRACT

A recording apparatus includes a power transmission unit configured to be in a power transmission state in which power of a motor is transmitted to a medium reception tray and a power non-transmission state in which the power of the motor is not transmitted to the medium reception tray, and a switching lever unit configured to switch between the power non-transmission state and the power transmission state. The switching lever unit rotates between a contact position and a non-contact position. When the switching lever unit is at the contact position, the switching lever unit switches between the power non-transmission state and the power transmission state by sliding in contact with the carriage as a carriage reciprocates.

The present application is based on, and claims priority from JP Application Serial Number 2023-135576, filed Aug. 23, 2023, and 2024-014213, filed Feb. 1, 2024, the disclosures of which are hereby incorporated by reference herein in its entirety.

### BACKGROUND

### 1. Technical Field

The present disclosure relates to a recording device.

### 2. Related Art

A recording apparatus represented by a facsimile machine, a printer, and the like may include a medium reception tray that receives a medium after recording and discharging. Further, as described in JP-A-2018-16480, such a medium reception tray may be configured to be switchable between an accommodation state and an extension state by a motor.

In the recording apparatus in the related art that includes the medium reception tray configured to be switchable between the accommodation state and the extension state by the motor as described in JP-A-2018-16480, in other words, the related-art recording medium including the medium reception tray that can be displaced between a first state and a second state, a configuration of a mechanism for switching the medium reception tray between the first state and the second state may be increased in size. Further, when this mechanism is increased in size, there may be a risk that the apparatus as a whole is increased in size.

### SUMMARY

In order to solve the above-mentioned problem, a recording apparatus according to the present disclosure includes a recording head attached to a carriage and configured to perform recording on a medium, the carriage being configured to reciprocate, a discharge roller configured to discharge the medium on which the recording was performed, a medium reception tray configured to receive the medium discharged by the discharge roller, the medium reception tray being configured to be in a first state and in a second state in which the medium reception tray is displaced from a position in the first state in a discharge direction of the medium, a motor being a power source of the discharge roller, a power transmission unit configured to be in a power transmission state in which power of the motor is transmitted from the motor to the medium reception tray and a power non-transmission state in which power of the motor is not transmitted from the motor to the medium reception tray, and a switching lever unit configured to switch between the power non-transmission state and the power transmission state, wherein the switching lever unit rotates between a contact position at which the switching lever unit is configured to come into contact with the carriage as the carriage reciprocates and a non-contact position at which the switching lever unit does not come into contact with the carriage even when the carriage moves, and when the switching lever unit is at the contact position, the switching lever unit performs switching between the power non-transmission state and the power transmission state by sliding in contact with the carriage as the carriage reciprocates.

### BRIEF DESCRIPTION OF THE DRAWINGS

FIG. 1 is a schematic view of a recording apparatus of a first embodiment of the present disclosure.

FIG. 2 is a side cross-sectional view illustrating an internal configuration of the recording apparatus in FIG. 1, and is a view illustrating a part thereof in an enlarged manner.

FIG. 3 is a plan cross-sectional view illustrating the internal configuration of the recording apparatus in FIG. 1, and is a view illustrating a part thereof in an enlarged manner from a different angle.

FIG. 4 is a plan cross-sectional view illustrating a periphery of a power transmission unit of the recording apparatus in FIG. 1.

FIG. 5 is a plan cross-sectional view illustrating the periphery of the power transmission unit of the recording apparatus in FIG. 1, and is a view from which the motor is omitted.

FIG. 6 is a side cross-sectional view illustrating the periphery of the power transmission unit of the recording apparatus in FIG. 1.

FIG. 7 is a perspective view illustrating the power transmission unit and the motor of the recording apparatus in FIG. 1.

FIG. 8 is a perspective view illustrating the power transmission unit and a carriage of the recording apparatus in FIG. 1, and is a view illustrating a state in which, within a reciprocating range, the carriage is on a side close to the power transmission unit, and a switching lever unit is at a non-contact position.

FIG. 9 is a perspective view illustrating the power transmission unit, the carriage, and a medium reception tray of the recording apparatus in FIG. 1, and is a view illustrating a state in which, within the reciprocating range, the carriage is on the side close to the power transmission unit, and the switching lever unit is at a contact position.

FIG. 10 is a perspective view illustrating the power transmission unit, the carriage, and the medium reception tray of the recording apparatus in FIG. 1, and is a view illustrating a state in which, within the reciprocating range, the carriage is at a home position on a side opposite to the side close to the power transmission unit.

FIG. 11 is a perspective view of the power transmission unit of the recording apparatus in FIG. 1, and is a view illustrating a state in which the switching lever unit is at the contact position.

FIG. 12 is a perspective view of the power transmission unit of the recording apparatus in FIG. 1, which is viewed from an angle different from FIG. 11, and is a view illustrating a state in which the switching lever unit is at the non-contact position.

FIG. 13 is a perspective view illustrating a state in which the switching lever unit of the recording apparatus in FIG. 1 is shifted from a state of being at the non-contact position to a state of being at the contact position.

FIG. 14 is a perspective view illustrating a state in which the switching lever unit of the recording apparatus in FIG. 1 is shifted from the state of being at the non-contact position to the state of being at the contact position, and the switching lever unit further slides.

FIG. 15 is a front cross-sectional view illustrating a state in which the switching lever unit of the recording apparatus in FIG. 1 is shifted from the state of being at the non-contact position to the state of being at the contact position, and the switching lever unit further slides.

FIG. 16 is a perspective cross-sectional view illustrating a state in which the switching lever unit of the recording apparatus in FIG. 1 is shifted from the state of being at the non-contact position to the state of being at the contact position, and the switching lever unit further slides.

FIG. 17 is a perspective view illustrating a periphery of a lock component and a transmission component of the power transmission unit of the recording apparatus in FIG. 1.

FIG. 18 is a perspective view of the periphery of the lock component and the transmission component of the power transmission unit of the recording apparatus in FIG. 1, which is viewed from an angle different from FIG. 17.

FIG. 19 is a perspective view of the periphery of the lock component and the transmission component of the power transmission unit of the recording apparatus in FIG. 1, which is viewed from an angle different from FIG. 17 and FIG. 18.

FIG. 20 is a perspective cross-sectional view of the power transmission unit of the recording apparatus in FIG. 1, and is a view illustrating a state in which the switching lever unit is at the contact position.

FIG. 21 is a perspective view illustrating a periphery of a friction toothed gear of the power transmission unit of the recording apparatus in FIG. 1.

FIG. 22 is a perspective cross-sectional view illustrating the periphery of the friction toothed gear of the power transmission unit of the recording apparatus in FIG. 1.

FIG. 23 is a perspective view illustrating the power transmission unit and the carriage of the recording apparatus in FIG. 1, and is a view illustrating arrangement of the switching lever unit with respect to the carriage when, within the reciprocating range, the carriage is on the side close to the power transmission unit, and the switching lever unit is at the non-contact position.

FIG. 24 is a view obtained by omitting the switching lever unit from FIG. 23.

FIG. 25 is a perspective view illustrating a unit including the power transmission unit of the recording apparatus in FIG. 1.

FIG. 26 is a perspective view obtained by omitting a second frame from the unit including the power transmission unit of the recording apparatus in FIG. 1.

FIG. 27 is a perspective view obtained by omitting the power transmission unit and the second frame from the unit including the power transmission unit of the recording apparatus in FIG. 1, in other words, a perspective view illustrating a first frame.

FIG. 28 is a perspective view illustrating a main body frame to which the unit including the power transmission unit of the recording apparatus in FIG. 1 is attached.

FIG. 29 is a perspective view illustrating a periphery of a switching lever unit and an ASF trigger lever unit of a recording apparatus of a second embodiment of the present disclosure.

FIG. 30 is a perspective view illustrating the ASF trigger lever unit of the recording apparatus in FIG. 29.

FIG. 31 is a cross-sectional view illustrating the periphery of the ASF trigger lever unit of the recording apparatus in FIG. 29.

FIG. 32 is a perspective view illustrating the periphery of the switching lever unit of the recording apparatus in FIG. 29, and is a view illustrating a state in which the switching lever unit is at the non-contact position.

FIG. 33 is a perspective view illustrating the periphery of the ASF trigger lever unit of the recording apparatus in FIG. 29, and is a view illustrating a state in which the ASF trigger lever unit is at a position of disabling an ASF operation.

FIG. 34 is a perspective view illustrating the periphery of the switching lever unit of the recording apparatus in FIG. 29, and is a view illustrating a state in which the switching lever unit is at a first contact position of contact positions.

FIG. 35 is a perspective view illustrating the periphery of the ASF trigger lever unit of the recording apparatus in FIG. 29, and is a view illustrating a state in which the ASF trigger lever unit is at a position of enabling the ASF operation.

FIG. 36 is perspective view illustrating the periphery of the switching lever unit of the recording apparatus in FIG. 29, and is view illustrating a state in which the switching lever unit is at a second contact position of the contact positions.

### DESCRIPTION OF EMBODIMENTS

First, the present disclosure is schematically described below.

In order to solve the above-mentioned problem, a recording apparatus according to a first aspect of the present disclosure includes a recording head attached to a carriage and configured to perform recording on a medium, the carriage being configured to reciprocate, a discharge roller configured to discharge the medium on which the recording was performed, a medium reception tray configured to receive the medium discharged by the discharge roller, the medium reception tray being configured to be in a first state and in a second state in which the medium reception tray is displaced from a position in the first state in a discharge direction of the medium, a motor being a power source of the discharge roller, a power transmission unit configured to be in a power transmission state in which power of the motor is transmitted from the motor to the medium reception tray and a power non-transmission state in which power of the motor is not transmitted from the motor to the medium reception tray, and a switching lever unit configured to switch between the power non-transmission state and the power transmission state, wherein the switching lever unit rotates between a contact position at which the switching lever unit is configured to come into contact with the carriage as the carriage reciprocates and a non-contact position at which the switching lever unit does not come into contact with the carriage even when the carriage moves, and when the switching lever unit is at the contact position, the switching lever unit switches between the power non-transmission state and the power transmission state by sliding in contact with the carriage as the carriage reciprocates.

According to the present aspect, there is provided the switching lever unit that switches the power transmission unit between the power non-transmission state and the power transmission state. The switching lever unit rotates between the contact position of contacting with the carriage as the carriage reciprocates and the non-contact position of not contacting with the carriage even when the carriage moves. When the switching lever unit is at the contact position, the switching lever unit performs switching between the power non-transmission state and the power transmission state by contacting with the carriage and sliding as the carriage reciprocates. With this configuration, the power switching mechanism and the switching lever for switching the power transmission unit between the power-non transmission state and the power transmission state can be arranged suitably, and the mechanism as a whole for switching the medium reception tray between the first state and the second state can be reduced in size. Further, with this, the recording apparatus as a whole can be reduced in size.

In a recording apparatus according to a second aspect of the present disclosure, which is an aspect dependent on the first aspect, when the switching lever unit is at the contact position, at least a distal portion thereof enters a reciprocating range of the carriage, and when the switching lever unit is at the non-contact position, the distal end portion exits from the reciprocating range of the carriage.

According to the present aspect, when the switching lever unit is at the contact position, at least a distal portion thereof enters a reciprocating range of the carriage, and when the switching lever unit is at the non-contact position, the distal end portion exits from the reciprocating range of the carriage. In this manner, at the non-contact position in the non-power transmission state, the distal end portion exits from the reciprocating range of the carriage. With this, there is no need to provide a switching lever unit outside of the reciprocating range of the carriage. As a result, the recording apparatus can particularly be reduced in size.

In a recording apparatus according to a third aspect of the present disclosure, which is an aspect dependent on the second aspect, the carriage is provided with a non-allowable portion being not allowed to make contact with the switching lever unit, a guard portion configured to guard the non-allowable portion is provided around the non-allowable portion, and the distal end portion is provided with a facing surface facing the guard portion.

According to the present aspect, the carriage is provided with a guard portion that guards a non-allowable portion in a periphery of the non-allowable portion that does not allow contact with the switching lever unit, and the distal end portion is provided with a facing surface facing the guard portion. Thus, even when the distal end portion contacts with the guard portion, the distal end portion can be prevented from contacting with the non-allowable portion.

In a recording apparatus according to a fourth aspect of the present disclosure, which is an aspect dependent on any one of the first aspect to the third aspect, the power transmission unit includes a lock component configured to prevent rotation of a gear when the power transmission unit is in the power non-transmission state and a transmission component configured to transmit power of the motor when the power transmission unit is in the power transmission state, and the switching lever unit switches coupling of the lock component and the transmission component in the power transmission unit by sliding in contact with the carriage.

According to the present aspect, the switching lever unit switches the coupling to the lock component and the transmission component in the power transmission unit by contacting with the carriage and sliding. With this configuration, the mechanism that prevents transmission of the power of the motor when being in the power non-transmission state and the mechanism that transmits the power of the motor when being in the power transmission state can be formed easily.

In a recording apparatus according to a fifth aspect of the present disclosure, which is an aspect dependent on the fourth aspect, the power transmission unit switches coupling from the lock component to the transmission component by applying an external load in a direction in which the switching lever unit slides in contact with the carriage.

According to the present aspect, the power transmission unit switches coupling from the lock component to the transmission component by applying an external load in a direction in which the switching lever unit slides in contact with the carriage. With this configuration, for example, when the power of the recording apparatus is turned off, a user can manually perform switching between the power transmission state and the power non-transmission state.

In a recording apparatus according to a sixth aspect of the present disclosure, which is an aspect dependent on the fourth or the fifth aspect, the power transmission unit includes a cam having a cam surface and a holding unit configured to hold the lock component and the transmission component and including a pin to be arranged on the cam surface, and the power transmission unit shifts between the power non-transmission state and the power transmission state when the pin moves on the cam surface.

According to the present aspect, when the pin of the holding unit that holds the lock component and the transmission component moves on the cam surface of the cam, the power transmission unit moves between the power non-transmission state and the power transmission state. With this configuration, the power transmission unit can be configured in a small size, and the recording apparatus can be particularly reduced in size.

In a recording apparatus according to a seventh aspect of the present disclosure, which is an aspect dependent on the sixth aspect, the cam surface is provided with a flat surface portion at which the pin is positioned when the power transmission unit is in the power non-transmission state, and a pin holding portion configured to hold the pin when the power transmission unit is in the power transmission state.

According to the present aspect, the cam surface is provided with a flat surface portion at which the pin is positioned when the power transmission unit is in the power non-transmission state, and a pin holding portion configured to hold the pin when the power transmission unit is in the power transmission state. With this configuration, when the power transmission unit is in the power transmission state, position deviation of the pin can be prevented.

A recording apparatus according to an eighth aspect of the present disclosure, which is an aspect dependent on any one of the first aspect to the seventh aspect, includes a frame to which the discharge roller is attached, wherein the power transmission unit is provided to a unit being a separate body from the frame and being configured to be attached to and detached from the frame.

According to the present aspect, the power transmission unit is provided to a unit being a separate body from the frame and being configured to be attached to and detached from the frame. With this configuration, attachment of the power transmission unit into the recording apparatus can be facilitated, and replacement, cleaning, or the like of the power transmission unit can be facilitated.

In a recording apparatus according to a ninth aspect of the present disclosure, which is an aspect dependent on any one of the first aspect to the eighth aspect, the switching lever unit located at the contact position is configured to be arranged at a first contact position and second contact position, where the switching lever unit and the carriage are contactable as the carriage reciprocates.

According to the present aspect, the switching lever unit is configured to be arranged at a first contact position and a second contact position for contacting with the carriage as the carriage reciprocates. Thus, the arrangement of the switching lever unit can be changed as required while maintaining the switching lever unit at the contact position.

In a recording apparatus according to a tenth aspect of the present disclosure, which is an aspect dependent on the ninth aspect, the switching lever unit is configured to be arranged at the first contact position and the second contact position by rotating.

According to the present aspect, the switching lever unit is configured to be arranged at the first contact position and the second contact position by rotating. Thus, the arrangement of the switching lever unit can be changed easily while maintaining the switching lever unit at the contact position.

In a recording apparatus according to an eleventh aspect of the present disclosure, which is an aspect dependent on the tenth aspect, the switching lever unit includes a contactable portion extending in a rotating direction and being contactable with the carriage.

According to the present aspect, the switching lever unit includes a contactable portion that is extended in a rotating direction and contacts with the carriage. With this configuration, in a case in which the switching lever unit is arranged at the first contact position or the second contact position, even when an error or the like is caused at the arrangement position, the switching lever can suitably be remained at the contact position.

### First Embodiment

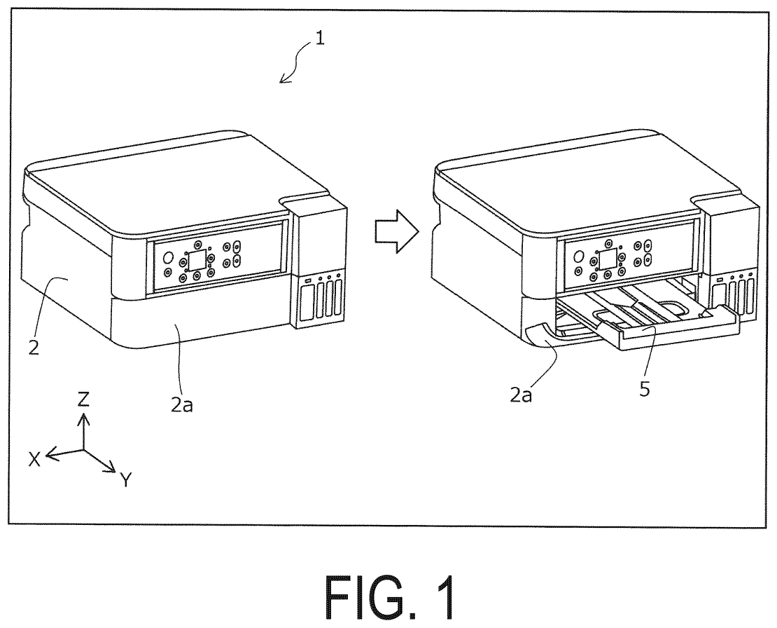

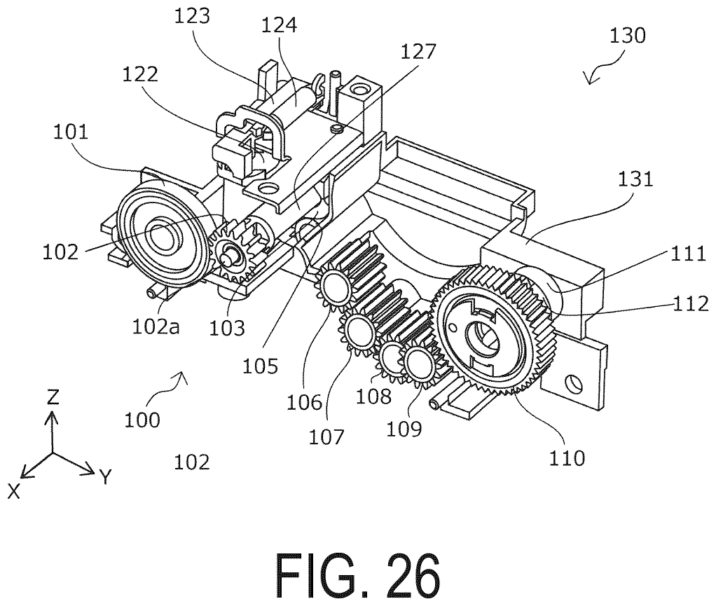

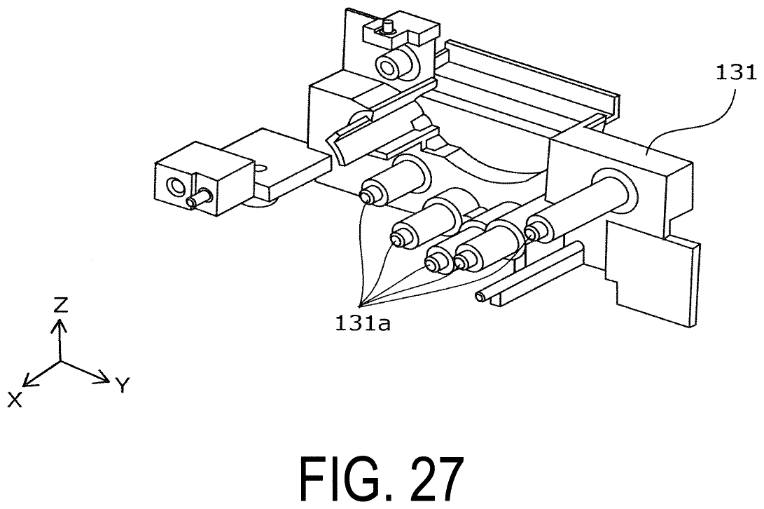

With reference to FIG. 1 to FIG. 28, the recording apparatus 1 of the first embodiment of the present disclosure is specifically described below. In the following description, three axes that are orthogonal to each other are referred to as an X axis, a Y axis, and a Z axis, respectively, as illustrated in each of the drawings. The Z axis direction corresponds to a vertical direction, in other words, a direction in which gravity acts. The X axis direction and the Y axis direction correspond to horizontal directions. In each of the drawings, directions indicated by the arrows of the three axes (X, Y, and Z) are +directions of the respective directions. For example, the X axis direction corresponds to a reciprocating direction of a carriage 3, a +X direction corresponds to a side on which a power transmission unit 100 is provided, and a −X direction corresponds to a side close to a home position of the carriage 3. Further, a +Y direction corresponds to a discharge direction of a medium reception tray 5.

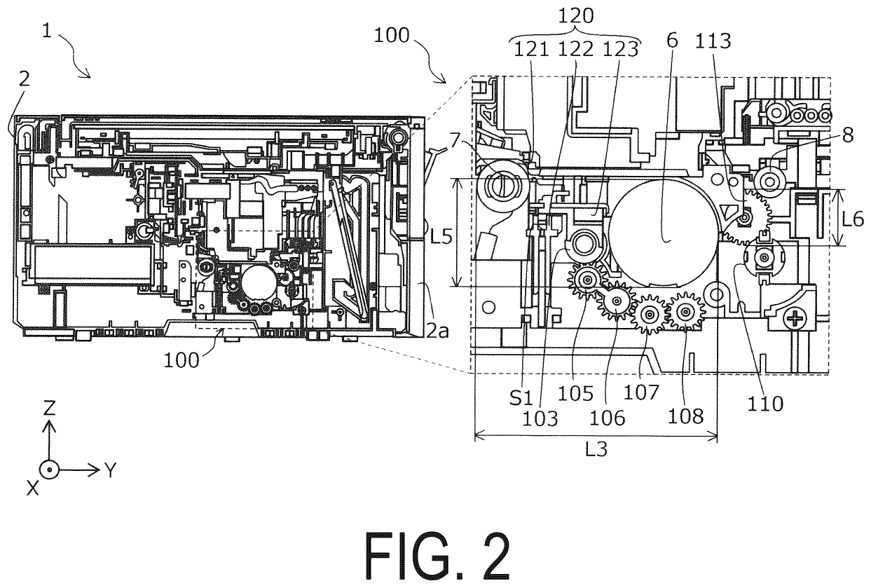

As illustrated in FIG. 1, the recording apparatus 1 of the present embodiment includes a casing 2. Further, as a part of the casing 2, a front cover 2a is provided. The recording apparatus 1 of the present embodiment can be displaced from the left part in FIG. 1 to the right part in FIG. 1. Specifically, the recording apparatus 1 is configured so that the medium reception tray 5 can be switched between a first state being an accommodation state and a second state being an extension state by the motor 6 illustrated in FIG. 2 or the like.

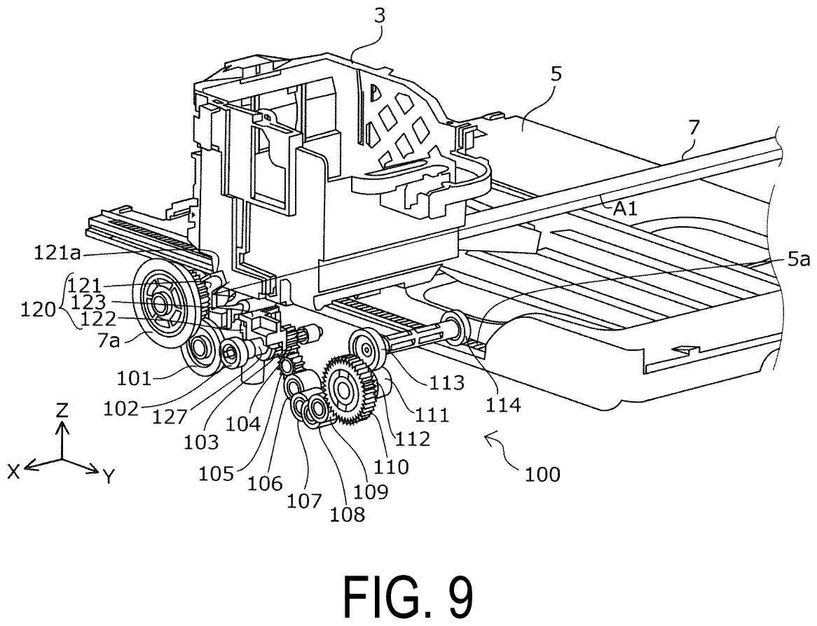

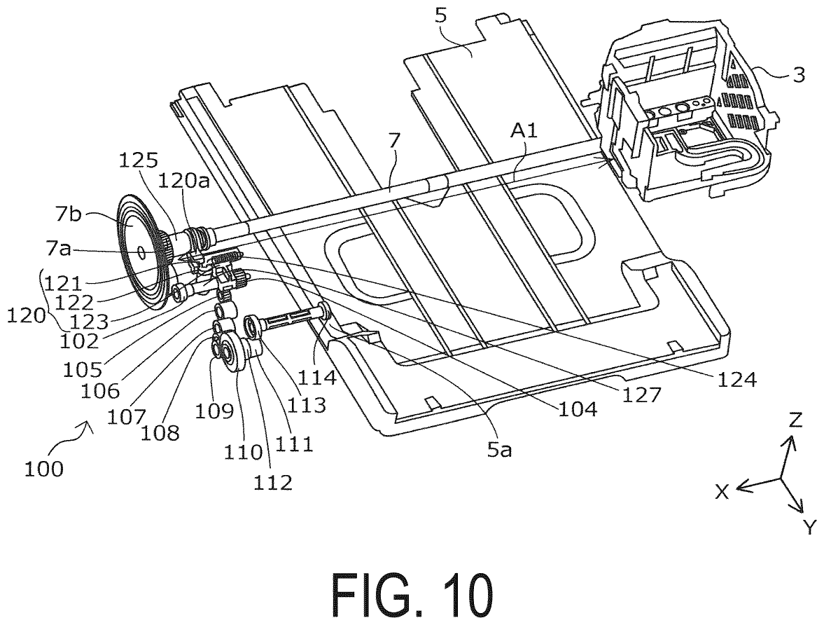

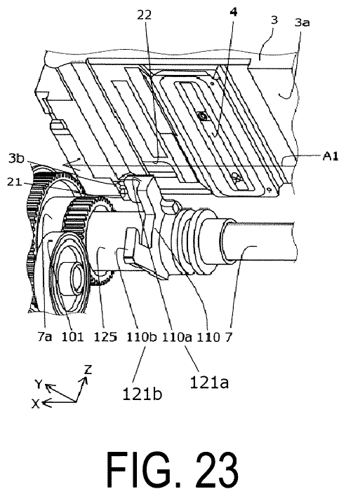

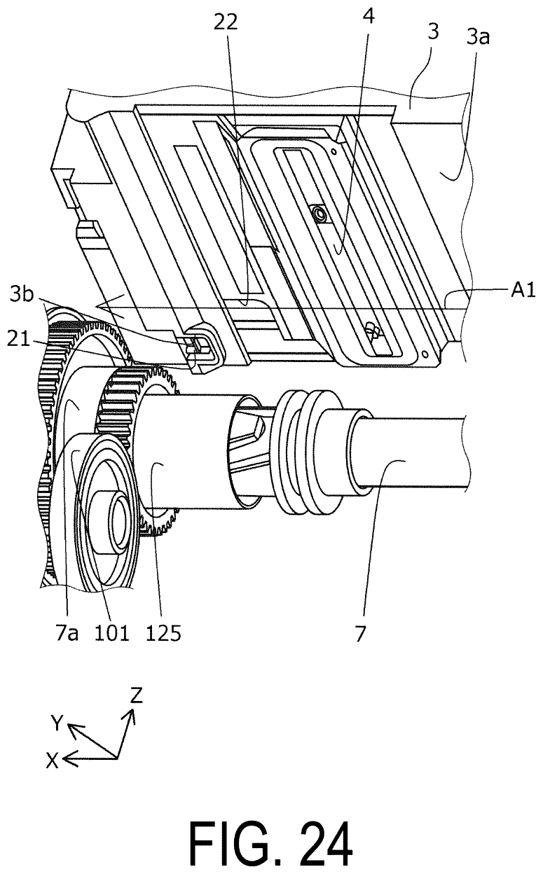

Herein, the recording apparatus 1 of the present embodiment includes, inside the casing 2, the carriage 3 that reciprocates along the X axis direction as illustrated in FIG. 9, FIG. 10, and the like, and a recording head 4 that is attached to the carriage 3 and performs recording on a medium as illustrated in FIG. 23 and FIG. 24. Further, the recording apparatus 1 of the present embodiment includes, inside the casing 2, a transport roller 7 that transports a medium and a discharge roller 8 that discharges the medium after recording, as illustrated in FIG. 2 and the like. Further, the recording apparatus 1 of the present embodiment includes, inside the casing 2, the medium reception tray 5 that receives the medium discharged by the discharge roller 8 as illustrated in FIG. 9, FIG. 10, and the like, and a motor 6 being a power source of the transport roller 7 and the discharge roller 8 as illustrated in FIG. 2 and the like.

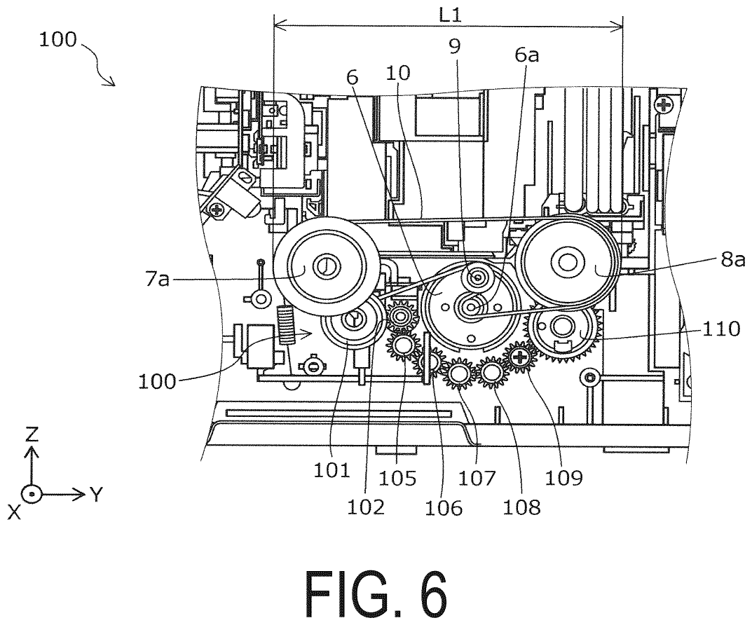

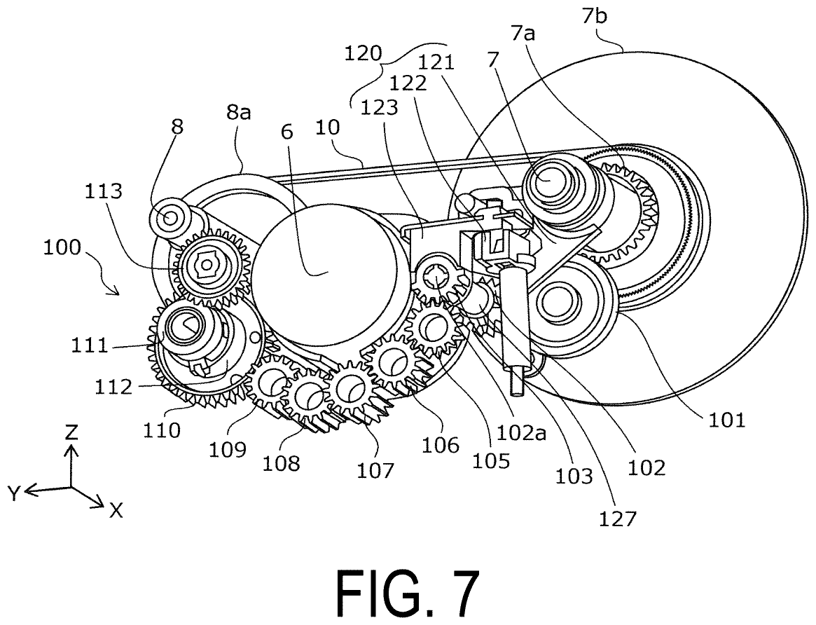

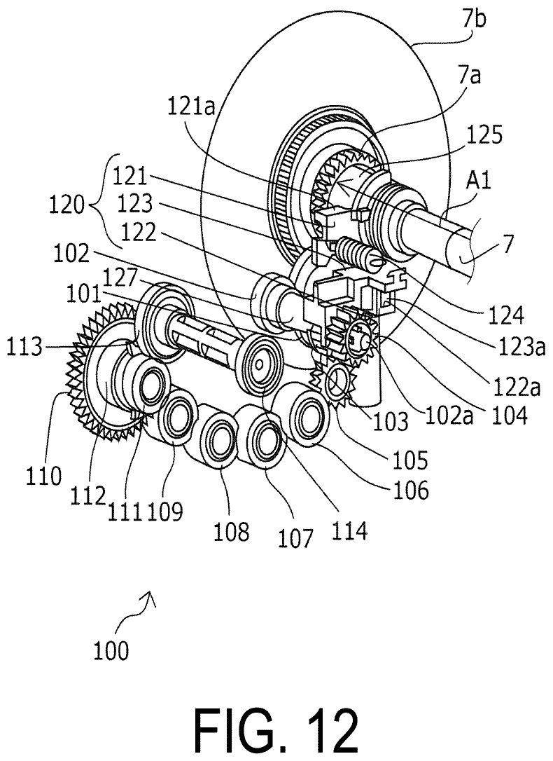

Transmission of power from the motor 6 to the transport roller 7 and the discharge roller 8 is performed in the following manner. As illustrated in FIG. 6, a motor pulley 6a is attached to the motor 6. A belt 10 is stretched around the motor pulley 6a. In addition to the motor pulley 6a, the belt 10 is stretched around a transport pulley 7a provided to the transport roller 7, a discharge roller pulley 8a provided to the discharge roller 8, and a pulley 9. As the rotation shaft of the motor 6 rotates, the motor pulley 6a rotates. With this, the belt 10 rotates. Further, the transport roller 7 and the discharge roller 8 rotate as the transport pulley 7a and the discharge roller pulley 8a rotate. Note that, as illustrated in FIG. 7, FIG. 12, and the like, the transport roller 7 is provided with an encoder 7b that measures rotation of the transport roller 7.

Herein, as described above, the medium reception tray 5 may be in the first state being the accommodation state and the second state being the extension state displaced in the discharge direction of the medium from the first state. Moreover, as illustrated in FIG. 2 and the like, the recording apparatus 1 of the present embodiment includes, inside the casing 2, the power transmission unit 100. Herein, the power transmission unit 100 may be in a power transmission state of transmitting the power of the motor 6 from the motor 6 to the medium reception tray 5 and a power non-transmission state of not transmitting the power of the motor 6 from the motor 6 to the medium reception tray 5.

Herein, the power transmission unit 100 is described. As illustrated in FIG. 7 to FIG. 12 and the like, the power transmission unit 100 includes a toothed gear 101 engaged with the transport pulley 7a. The toothed gear 101 is engaged with a toothed gear 102, and a rotation shaft 102a of the toothed gear 102 is provided with a lock component 103 being a D-shaped toothed gear and a transmission component 104 being a toothed gear. The rotation shaft 102a of the toothed gear 102, the lock component 103, and the transmission component 104 is a direction along the X axis direction, and the lock component 103 and the transmission component 104 are configured to move integrally along the X axis direction by a power switching mechanism 120. Note that, although details of the power switching mechanism 120 are described later, the lock component 103 is configured not to rotate by interfering with a holding unit 123 forming a part of the power switching mechanism 120, and the transmission component 104 is configured to rotate as the toothed gear 102 rotates.

Further, as illustrated in FIG. 7 to FIG. 12 and the like, the power transmission unit 100 includes a toothed gear 105. Thus, when the power switching mechanism 120 moves the lock component 103 and the transmission component 104 along the X axis direction, the toothed gear 105 and the lock component 103 can be engaged with each other, and the toothed gear 105 and the transmission component 104 can be engaged with each other. Note that, with the configuration described above, in a case in which the toothed gear 102 rotates, when the toothed gear 105 and the lock component 103 are engaged with each other, the toothed gear 105 does not rotate. When the toothed gear 105 and the transmission component 104 are engaged with each other, the toothed gear 105 rotates.

Further, as illustrated in FIG. 7 to FIG. 12 and the like, the toothed gear 105 is engaged with a toothed gear 106, the toothed gear 106 is engaged with a toothed gear 107, the toothed gear 107 is engaged with a toothed gear 108, and the toothed gear 108 is engaged with a toothed gear 109. The toothed gear 109 is engaged with a toothed gear 110. The toothed gear 110 is engaged with a toothed gear 111, which shares the same rotary shaft, via a friction forming portion 112. In other words, the toothed gear 110, the toothed gear 111, and the friction forming portion 112 form a friction toothed gear. Further, the toothed gear 111 is engaged with a toothed gear 113 being a final stage of a driving wheel train of the power transmission unit 100. The toothed gear 113 is configured to be rotatable with a pinion 114, which shares the same rotary shaft, and the pinion 114 is engaged with a rack 5a formed on the medium reception tray 5. Thus, as the toothed gear 113 rotates, the medium reception tray 5 is movable along the Y axis direction. In this manner, the power transmission unit 100 of the present embodiment includes the power switching mechanism 120 and the driving wheel train from the toothed gear 101 to the toothed gear 113.

Herein, in the recording apparatus 1 of the present embodiment, as illustrated in FIG. 6, the power transmission unit 100 is positioned in a region L1 between an outer end portion of the transport pulley 7a and an outer end portion of the discharge roller pulley 8a in the Y axis direction corresponding to the discharge direction of the medium. When the power transmission unit 100 is arranged on the distal end side in the discharge direction with respect to the discharge roller pulley 8a, the apparatus as a whole is likely to protrude to the +Y direction being the distal end side in the discharge direction. When the power transmission unit 100 is arranged in the −Y direction being the rear end side in the discharge direction with respect to the transport pulley 7a, the apparatus as a whole is likely to protrude to the rear end side in the discharge direction. However, when the power transmission unit 100 is arranged as described above, the length of the recording apparatus 1 as a whole in the discharge direction can be reduced. Therefore, according to the recording apparatus 1 of the present embodiment, size reduction of the recording apparatus including the medium reception tray 5 that can be displaced in the first state and the second state is achieved.

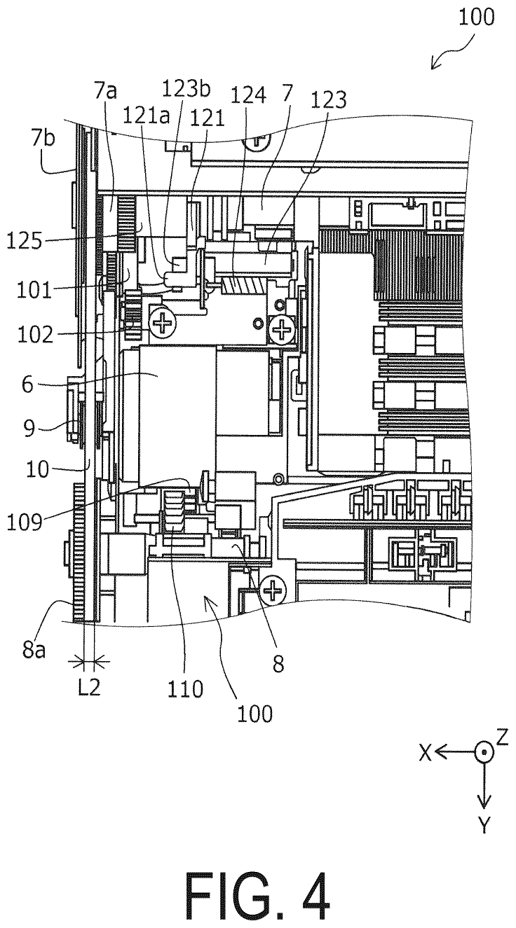

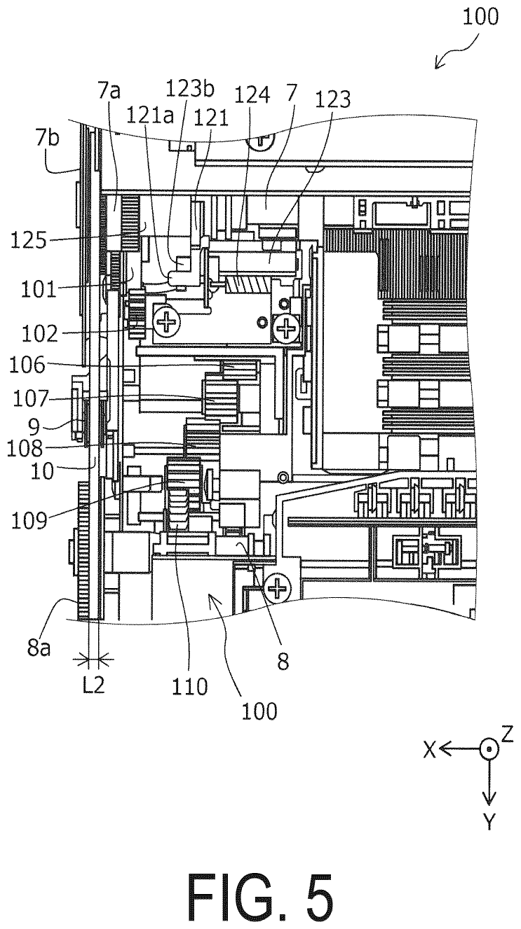

Further, as illustrated in FIG. 4 and FIG. 5, the power transmission unit 100 of the present embodiment is positioned on the inner side close to the center of the recording apparatus 1, in other words, on the −X direction side in FIG. 4 and FIG. 5 in the X axis direction corresponding to the reciprocating direction of the carriage 3 with respect to a routing range L2 of the belt 10. When the power transmission unit 100 is positioned on the outer side of the recording apparatus 1 in the reciprocating direction of the carriage 3 with respect to the routing range of the belt 10, the apparatus as a whole is likely to protrude in the reciprocating direction of the carriage 3. However, with the configuration described above, the length of the recording apparatus 1 as whole in the reciprocating direction of the carriage 3 can be reduced. Therefore, according to the recording apparatus 1 of the present embodiment, size reduction of the recording apparatus including the medium reception tray 5 that can be displaced in the first state and the second state is particularly achieved.

Further, as illustrated in FIG. 6, the power transmission unit 100 of the present embodiment is positioned in the periphery of the motor 6 as viewed in the direction along the reciprocating direction of the carriage 3. In other words, the power transmission unit 100 is arranged while bypassing the motor 6. Thus, the recording apparatus 1 of the present embodiment prevents the power transmission unit 100 from interfering with the motor 6.

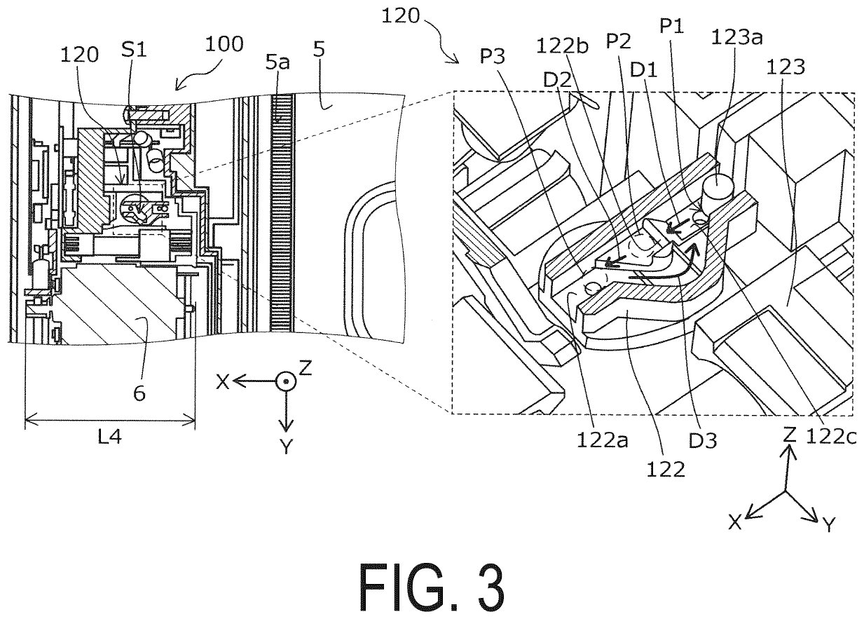

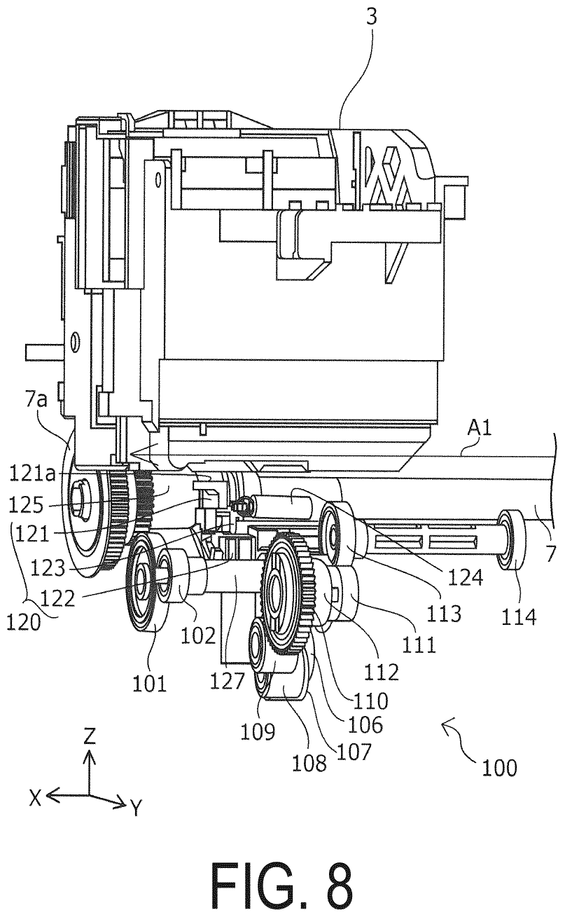

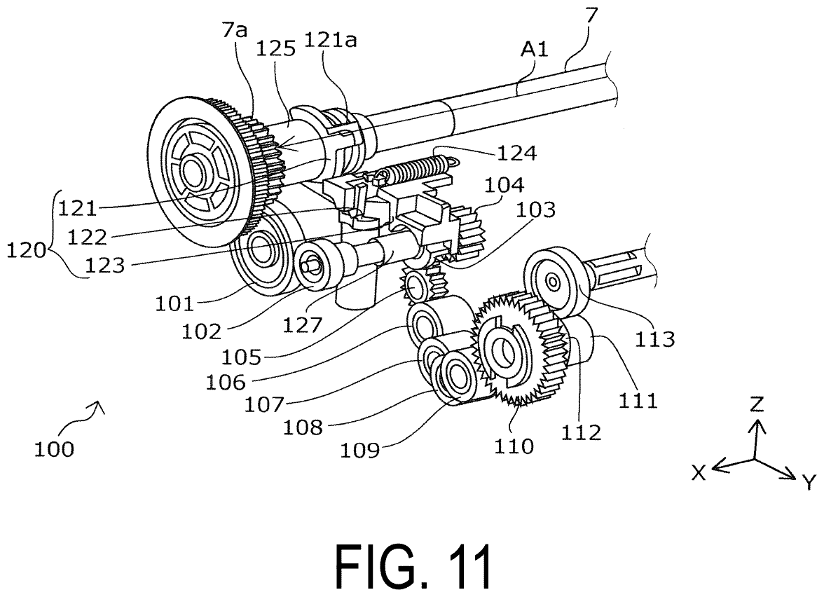

Next, in view of arrangement of the power switching mechanism 120, the recording apparatus 1 of the present embodiment is described. As illustrated in FIG. 8 to FIG. 12, the recording apparatus 1 of the present embodiment includes a switching lever unit 121, a cam 122, and the holding unit 123 as the power switching mechanism 120. The switching lever unit 121 switches the power transmission unit 100 between the power transmission state and the power non-transmission state. As illustrated in FIG. 3, the cam 122 includes a cam surface 122a. The holding unit 123 holds the lock component 103 and the transmission component 104 as illustrated in FIG. 11 and the like, where a pin 123a is arranged on the cam surface 122a as illustrated in FIG. 3. Further, although details are described later, the power switching mechanism 120 can perform switching between the power non-transmission state and the power transmission state by the switching lever unit 121. Further, as illustrated in FIG. 2, the power switching mechanism 120 is positioned in a region L3 between an outer end portion of the motor 6 and the outer end portion of the transport roller 7 in the Y axis direction corresponding to the discharge direction of the medium. Note that, for example, the position of the power switching mechanism 120 may be a position S1 being a contact position between the cam surface 122a and the pin 123a, which is illustrated in FIG. 3.

When the power switching mechanism 120 is arranged on the distal end side (the +Y direction) with respect to the outed end portion of the motor 6, the apparatus as a whole is likely to protrude to the distal end side in the discharge direction (the +Y direction). When the power switching mechanism 120 is arranged on the rear end side in the discharge direction (the −Y direction) with respect to the outer end portion of the transport roller 7, the apparatus as a whole is likely to protrude to the rear end side in the discharge direction (the −Y direction). However, when the power switching mechanism 120 is arranged in this manner, the length of the recording apparatus 1 as whole in the discharge direction (the Y axis direction) can be reduced. Therefore, according to the recording apparatus 1 of the present embodiment, size reduction of the recording apparatus including the medium reception tray 5 that can be displaced in the first state and the second state is achieved.

Further, as illustrated in FIG. 3, the position S1 of the power switching mechanism 120 of the present embodiment overlaps with an occupied range L4 of the motor 6 in the reciprocating direction of the carriage 3 (the X axis direction). Moreover, as illustrated in FIG. 2, the position S1 of the power switching mechanism 120 of the present embodiment overlaps with an occupied range L5 of the motor 6 in the Z axis direction corresponding to the intersecting direction that intersects with both the discharge direction (the Y axis direction) and the reciprocating direction of the carriage (the X axis direction).

In this manner, the power switching mechanism 120 may overlap with the motor 6 in at least one of the reciprocating direction of the carriage 3 (the X axis direction) or the intersection direction (the Z axis direction). With this configuration, in at least one of the reciprocating direction of the carriage 3 (the X axis direction) or the intersection direction (the Z axis direction), the power switching mechanism 120 can be arranged efficiently with respect to the motor 6. As a result, the recording apparatus including the medium reception tray 5 that can be displaced in the first state and the second state can particularly be reduced in size.

Further, as illustrated in FIG. 2, the position S1 of the power switching mechanism 120 of the present embodiment overlaps with an occupied range L6, which is the toothed gear 113 being the final stage of the driving wheel train of the power transmission unit 100, in the intersection direction (the Z axis direction). The power switching mechanism 120 of the present embodiment is thus configured. Thus, in the intersection direction (the Z axis direction), the power switching mechanism 120 can be arranged efficiently with respect to the driving wheel train of the power transmission unit 100. Thus, the recording apparatus 1 of the present embodiment including the medium reception tray 5 that can be displaced in the first state and the second state can particularly be reduced in size.

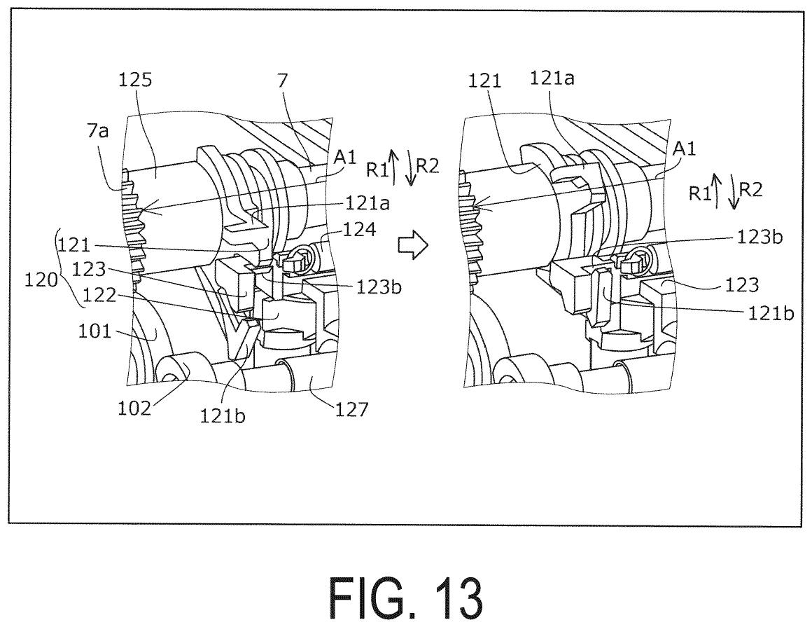

An operation of the power transmission unit 100, particularly, the switching lever unit 121 of the power switching mechanism 120, an accompanying operation of the driving wheel train of the power transmission unit 100, and a relationship with an operation of the carriage 3 are described below. As illustrated in FIG. 8, FIG. 9, and the like, the switching lever unit 121 is provided in the X axis direction within a reciprocating range A1 of the carriage 3. The reciprocating range A1 of the carriage 3 indicates a presence region of the carriage 3 as the carriage 3 reciprocates. The switching lever unit 121 is configured to rotate between a contact position and a non-contact position. As illustrated in FIG. 9, the right part in FIG. 13, and the like, at the contact position, a distal end portion 121a being a part of the switching lever unit 121 can contact with the carriage 3 as the carriage 3 reciprocates. As illustrated in FIG. 8, the left part in FIG. 13, and the like, at the non-contact position, any part of the switching lever unit 121 does not contact with the carriage 3 even when the carriage 3 moves. Specifically, the motor 6 rotates in a forward rotation direction being a rotation direction at the time of transporting the medium, and the transport roller 7 rotates a rotation direction R1 in FIG. 13. With this, the switching lever unit 121 is shifted from the non-contact position in the left side state in FIG. 13, which is an initial state, to the contact position in the right side state in FIG. 13. Note that, in the initial state, the switching lever unit 121 is biased in a rotation direction R2.

As illustrated in FIG. 13, the switching lever unit 121 includes the distal end portion 121a and an engaging portion 121b. The distal end portion 121a enters or exits from the reciprocating range A1 of the carriage 3 by rotating. At the non-contact position, the engaging portion 121b is not engaged with an engaged portion 123b of the holding unit 123. At the contact position, the engaging portion 121b is engaged with the engaged portion 123b of the holding unit 123. Herein, the switching lever unit 121 is urged to the −X direction side by an elastic member 125, and the holding unit 123 is biased to the −X direction side by a coil sprint 124. However, when the switching lever unit 121 is at the contact position, the switching lever unit 121 contacts with the carriage 3 and slides in the +X direction as the carriage 3 reciprocates. With this, the holding unit 123 slides in the +X direction together with the switching lever unit 121. Further, when the holding unit 123 slides in the +X direction together with the switching lever unit 121, the power transmission unit 100 is switched between the power non-transmission state and the power transmission state.

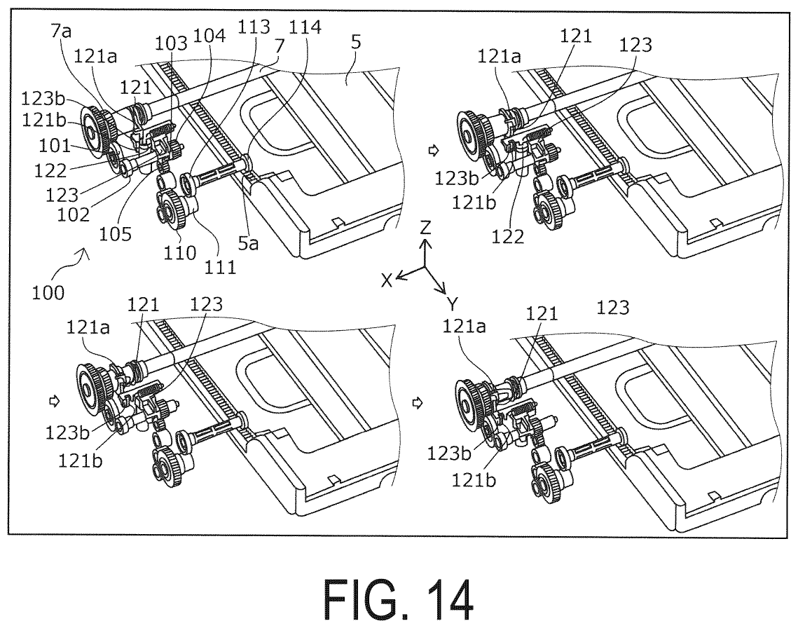

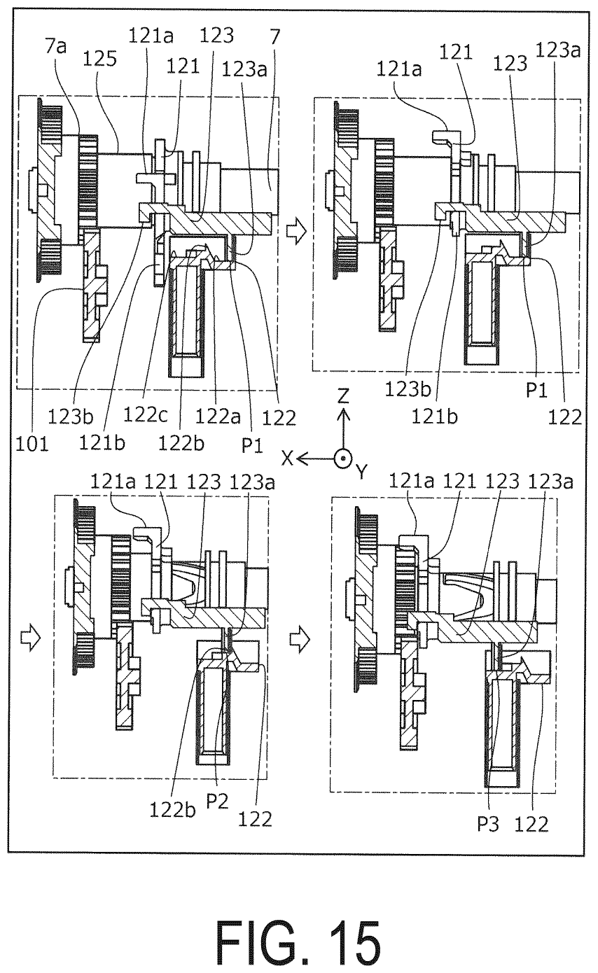

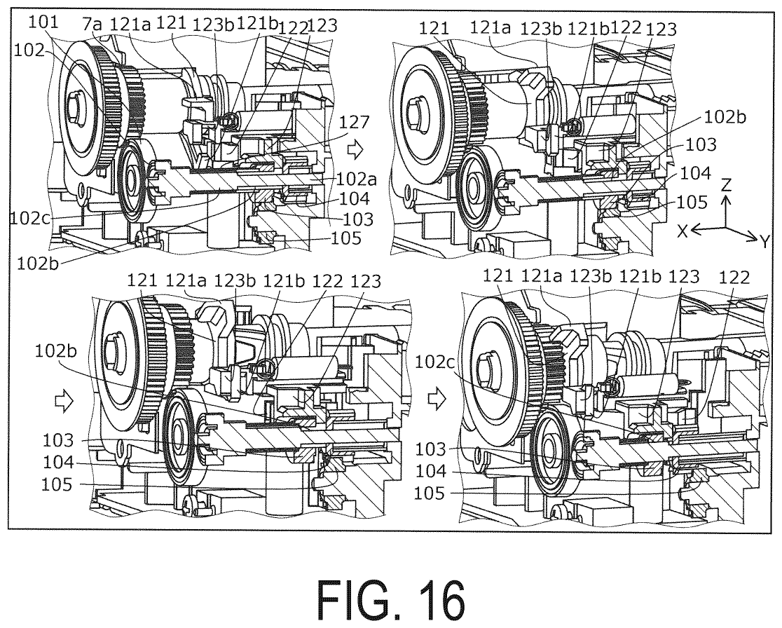

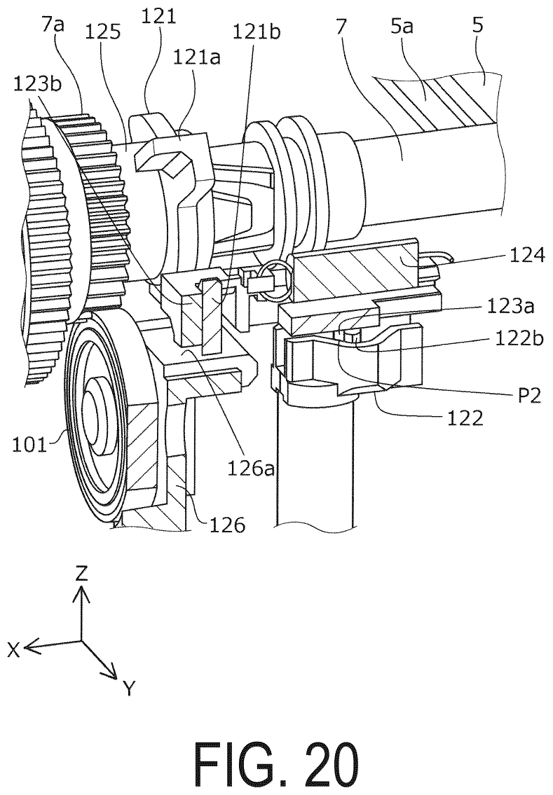

With reference to FIG. 3, FIG. 14, FIG. 15, FIG. 16, and FIG. 20, a procedure of switching the power transmission unit 100 from the power non-transmission state to the power transmission state is described below. All of FIG. 14, FIG. 15, and FIG. 16 illustrate a state in which the power transmission unit 100 is switched from the power non-transmission state to the power transmission state. All of the upper left parts in FIG. 14, FIG. 15, and FIG. 16 correspond to the left part in FIG. 13, and illustrate a state in which the switching lever unit 121 is at the non-contact position, which is the initial state. Note that, in this state, the position of the pin 123a of the holding unit 123 with respect to the cam surface 122a of the cam 122 is a first position P1 in FIG. 3.

Next, the motor 6 rotates in the forward direction, and thus the state is shifted from the state in the upper left parts in FIG. 14, FIG. 15, and FIG. 16 to the state in the upper right parts in FIG. 14, FIG. 15, and FIG. 16. This corresponds to the shift from the state corresponding to the left part in FIG. 13 to the right part in FIG. 13 when the switching lever unit 121 rotates. Specifically, the switching lever unit 121 rotates in the rotation direction R1, the distal end portion 121a enters the reciprocating range A1 of the carriage 3, and the engaging portion 121b is engaged with the engaged portion 123b. Note that, in this state, the position of the pin 123a of the holding unit 123 with respect to the cam surface 122a of the cam 122 is also the first position P1 in FIG. 3. Herein, in the state in the upper left parts in FIG. 14, FIG. 15, and FIG. 16 and the upper right parts in FIG. 14, FIG. 15, and FIG. 16, the toothed gear 105 and the lock component 103 are engaged with each other, and the power transmission unit 100 is in the power non-transmission state.

Next, the distal end portion 121a contacts with the carriage 3, and the switching lever unit 121 is pushed in the +X direction. With this, the state is shifted from the state in the upper right parts in FIG. 14, FIG. 15, and FIG. 16 to the state in the lower left parts in FIG. 14, FIG. 15, and FIG. 16. Note that, in FIG. 14, FIG. 15, and FIG. 16, illustration is given while omitting the carriage 3. Note that, in this state, the position of the pin 123a of the holding unit 123 with respect to the cam surface 122a of the cam 122 is a second position P2 in FIG. 3. The pin 123a moves from the first position P1 to the second position P2 along a movement path D1. At the second position P2 in FIG. 3, a pin holding portion 122b that hooks and holds the pin 123a on the cam surface 122a is formed. Herein, in the state in the lower left parts in FIG. 14, FIG. 15, and FIG. 16, the toothed gear 105 and the transmission component 104 are engaged with each other, and the power transmission unit 100 is in the power transmission state. Further, as illustrated in FIG. 20, when the position of the pin 123a of the holding unit 123, which is illustrated in the state in the lower left parts in FIG. 14, FIG. 15, and FIG. 16, is the second position P2, the engaging portion 121b and the engaged portion 123b are configured to be supported on an upper surface 126a of a support frame 126 of the toothed gear 101. Thus, disengagement between the engaging portion 121b and the engaged portion 123b can be prevented.

Next, the distal end portion 121a contacts with the carriage 3, and the switching lever unit 121 is further pushed in the +X direction. With this, the state is shifted from the state in the lower left parts in FIG. 14, FIG. 15, and FIG. 16 to the state in the lower right parts in FIG. 14, FIG. 15, and FIG. 16. Note that, in this state, the position of the pin 123a of the holding unit 123 with respect to the cam surface 122a of the cam 122 is a third position P3 in FIG. 3. The pin 123a moves from the second position P2 to the third position P3 along a movement path D2. Note that, at the third position P3, a configuration, such as the pin holding portion 122b, for holding the pin 123a is not formed. Thus, as the carriage 3 moves in the −X direction, the position of the pin 123a of the holding unit 123 with respect to the cam surface 122a of the cam 122 returns to the first position P1 by a biasing force of the elastic member 125 acting in the −X direction. The pin 123a moves from the third position P3 to the first position P1 along a movement path D3.

The recording apparatus 1 of the present embodiment is thus configured. As a result, the power switching mechanism 120 and the switching lever unit 121 for switching the power transmission unit 100 between the power-non transmission state and the power transmission state can be arranged suitably, and the mechanism as a whole for switching the medium reception tray 5 between the first state and the second state can be reduced in size. Further, with this, the recording apparatus 1 as a whole can be reduced in size.

Further, as described above, when the switching lever unit 121 of the recording apparatus 1 of the present embodiment is at the contact position, at least the distal end portion 121a enters the reciprocating range A1 of the carriage 3 as described in FIG. 9 and the right part in FIG. 13. At the non-contact position, the distal end portion 121a exits from the reciprocating range A1 of the carriage 3 as illustrated in FIG. 8 and the left part in FIG. 13. In this manner, at the non-contact position in the non-power transmission state, the distal end portion 121a exits from the reciprocating range A1 of the carriage 3. With this, there is no need to provide the switching lever unit 121 outside of the reciprocating range A1 of the carriage 3. As a result, the recording apparatus 1 can particularly be reduced in size.

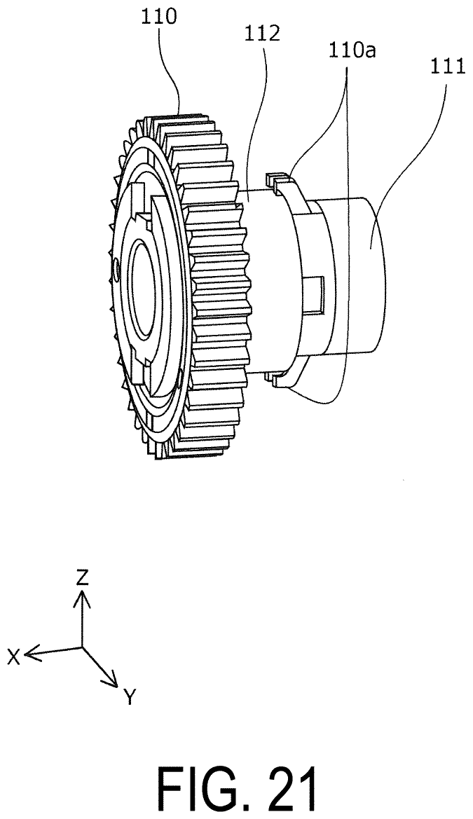

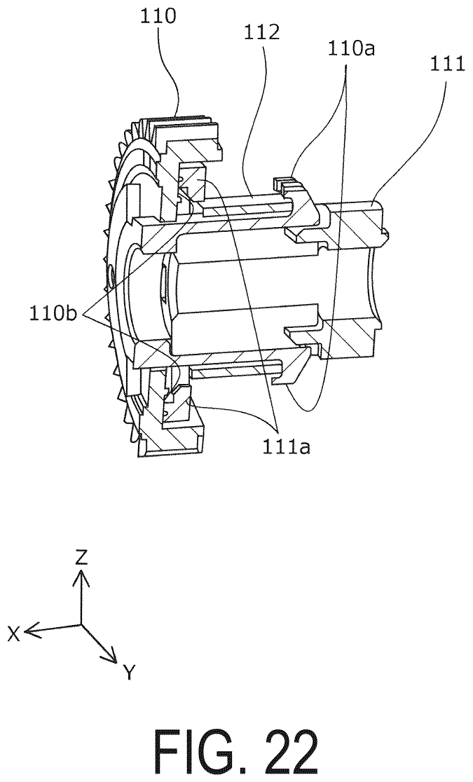

Further, as described above, in the recording apparatus 1 of the present embodiment, the power transmission unit 100 includes the lock component 103 and the transmission component 104. When the power transmission unit 100 is in the power non-transmission state as illustrated in the upper right parts in FIG. 14 and FIG. 16, and the like, the lock component 103 prevents rotation of the toothed gear. When the power transmission unit 100 is in the power transmission state as illustrated in the lower left parts in FIG. 14 and FIG. 16, and the like, the transmission component 104 transmits the power of the motor 6. Further, as apparent from comparison between the upper right parts in FIG. 14 and FIG. 16 and the lower left parts in FIG. 14 and FIG. 16, the switching lever unit 121 switches the coupling of the lock component 103 and the transmission component 104 with respect to of the toothed gear 105 in the power transmission unit 100, by contacting the carriage 3 and sliding in the +X direction. The recording apparatus 1 of the present embodiment is thus configured. Thus, the mechanism that prevents rotation of the toothed gear when being in the power non-transmission state and the mechanism that transmits the power of the motor 6 when being in the power transmission state are formed easily. Further, in the recording apparatus 1 of the present embodiment, when the medium reception tray 5 is manually operated, the friction toothed gear illustrated in FIG. 21 and FIG. 22 generates a load. The purpose of generating the load is to prevent movement of the medium reception tray 5 due to the own weight when it is inclined for accommodation of the recording apparatus 1 or the like or generate a sense of operation of a manual operation. Note that, at the time of power transmission, the coupling to the lock component 103 and the transmission component 104 is switched, the locking of the wheel train is canceled, and the medium reception tray 5 is driven by the motor power.

Herein, the power transmission unit 100 is configured to switch the coupling from the lock component 103 to the transmission component 104 with respect to the toothed gear 105, not only by contacting with the carriage 3 and applying an external load but also by, for example, applying an external load manually by a user, in the +X direction in which the switching lever unit 121 contacts with the carriage 3 and slides. The recording apparatus 1 of the present embodiment is thus configured. Thus, for example, when the power of the recording apparatus 1 is turned off, a user can manually perform switching between the power transmission state and the power non-transmission state. In addition, the number of components of the mechanism that enables a user to manually perform switching between the power transmission state and the power non-transmission state can be reduced.

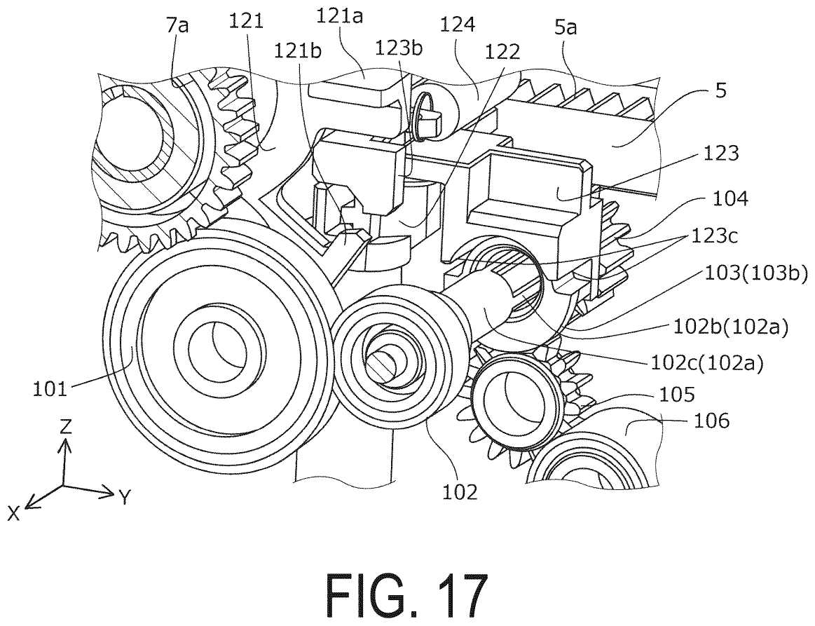

Herein, with reference to FIG. 16 to FIG. 19, the configuration of the switching mechanism for the coupling from the lock component 103 to the transmission component 104 with respect to the toothed gear 105 in the power transmission unit 100 is described. Herein, FIG. 17 to FIG. 19 illustrate the upper left state in FIG. 16, in other words, the state in which the position of the pin 123a of the holding unit 123 with respect to the cam surface 122a of the cam 122 is the first position P1 in FIG. 3. Further, for easy understanding of the shape of the rotation shaft 102a of the toothed gear 102, a compression spring 127, which is described later, is omitted in illustration in FIG. 17.

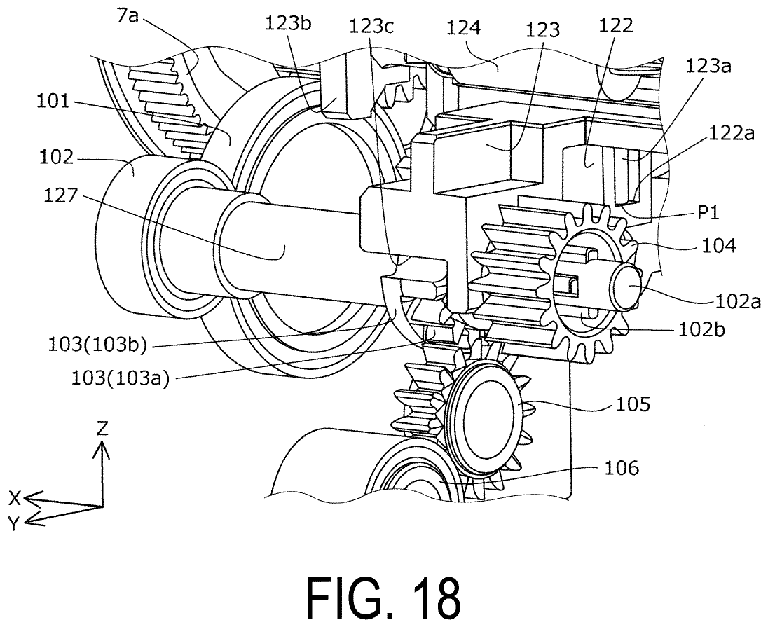

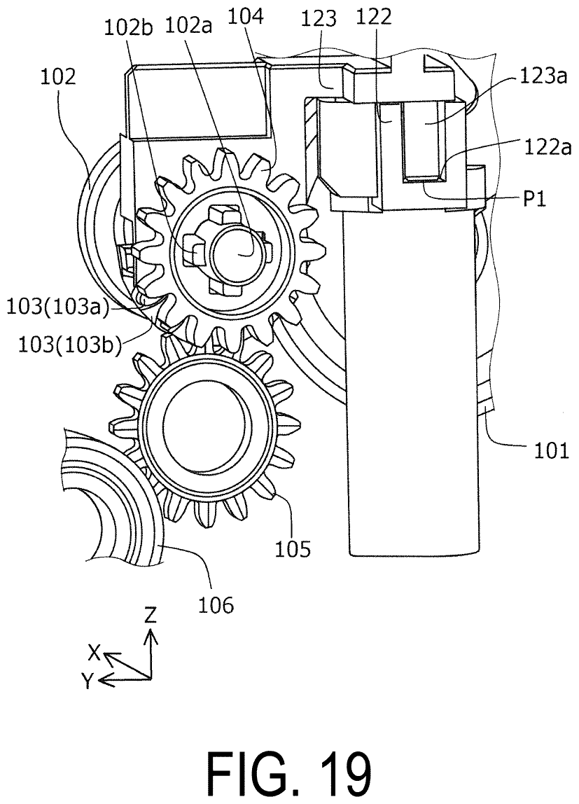

As illustrated in FIG. 18 and FIG. 19, a region on the −X direction side with respect to the center of the rotation shaft 102a of the toothed gear 102 is a cross-like shape 102b. As illustrated in FIG. 19, the transmission component 104 is provided with a hole portion having a cross-like shape that is fitted to the cross-like shape 102b of the rotation shaft 102a, and the transmission component 104 is configured to rotate at all times as the rotation shaft 102a rotates. Meanwhile, as illustrated in FIG. 16 and FIG. 17, the lock component 103 is provided with a circular hole through which the rotation shaft 102a passes. Further, in any one of the upper left state in FIG. 16 in which the lock component 103 faces the region of the cross-like shape 102b of the rotation shaft 102a, the upper right state in FIG. 16 and the lower left state in FIG. 16, or the lower left state in FIG. 16 in which the lock component 103 faces the columnar region 102c being a region other than the cross-like shape 102b of the rotation shaft 102a, even when the rotation shaft 102a rotates, the lock component 103 is configured not to rotate therewith. Note that, as illustrated in FIG. 17, a flange portion 103b, which is described later, has a substantially D-like shape. Even when the rotation shaft 102a rotates to almost cause rotation of the lock component 103, the lock component 103 is configured not to rotate therewith because an abutted portion 123c of the holding unit 123 and the flange portion 103b abut each other.

Note that, as illustrated in FIG. 18 and the like, the compression spring 127 is provided to the rotation shaft 102a between the toothed gear 102 and the lock component 103, and the lock component 103 is biased by the compression spring 127 to the −X direction side in a side away from the toothed gear 102. Further, the lock component 103 is provided with a tooth portion 103a on the −X direction side and the flange portion 103b having a substantially D-like shape on the +X direction side. The compression spring 127 described above is provided, and the lock component 103 is thus configured. Thus, even when the lock component 103 is configured so that, even when the lock component 103 temporarily comes into contact with the toothed gear 105, the teeth of the both components are engaged easily to achieve suitable positioning. In addition, the compression spring 127 described is provided. With this, when the state is shifted from the upper right state in FIG. 16 to the lower left state in FIG. 16, the transmission component 104 is configured so that, even when the transmission component 104 temporarily comes into contact with the toothed gear 105, the teeth of the both components are engaged easily.

Note that, as illustrated in FIG. 3, the power switching mechanism 120 of the power transmission unit 100 includes the cam 122 including the cam surface 122a and the holding unit 123 that holds the lock component 103 and the transmission component 104, where the pin 123a is arranged on the cam surface 122a. As described above, the pin 123a moves on the cam surface 122a between the first position P1, the second position P2, and the third position P3. With this, the power switching mechanism 120 moves between the power non-transmission state and the power transmission state. The recording apparatus 1 of the present embodiment is thus configured. As a result, the power transmission unit 100 can be configured in a small size, and the recording apparatus 1 can particularly be reduced in size.

Further, as illustrated in FIG. 3, the cam surface 122a is provided with a flat surface portion 122c on which the pin 123a is positioned when the power transmission unit 100 is in the power non-transmission state, in other words, the pin 123a is at the position other than the second position P2 on the cam surface 122a. Further, the cam surface 122a is provided with the pin holding portion 122b. The pin holding portion 122b holds the pin 123a when the power transmission unit 100 is in the power transmission state, in other words, the pin 123a is at the second position P2 on the cam surface 122a. With this configuration, when the power transmission unit 100 is in the power transmission state, position deviation of the pin 123a can be prevented.

Next, with reference to FIG. 21 and FIG. 22, the configuration of the toothed gear 110, the toothed gear 111, and the friction forming portion 112, in other words, the friction toothed gear composed of those components is described. As illustrated in FIG. 21 and FIG. 22, the toothed gear 110 includes a hook portion 110a formed on the −X direction side. Further, as illustrated in FIG. 22, the toothed gear 111 includes an abutting portion 111a formed on the +X direction side. The abutting portion 111a abuts a wall portion 110b of the toothed gear 110. When an abutting force of the abutting portion 111a with respect to the wall portion 110b is large, the toothed gear 111 is likely to rotate with the toothed gear 110. When an abutting force of the abutting portion 111a with respect to the wall portion 110b is small, the toothed gear 111 slips with respect to the toothed gear 110, and is less likely to rotate with the toothed gear 110. Herein, as illustrated in FIG. 21 and FIG. 22, the friction forming portion 112 being a compression spring is formed between the hook portion 110a and the abutting portion 111a. With this, an abutting force of the abutting portion 111a with respect to the wall portion 110b is obtained as an appropriate abutting force.

Next, a configuration of a head forming surface 3a of the carriage 3, which is a facing surface with respect to the switching lever unit 121, is described with reference to FIG. 23 and FIG. 24. Herein, FIG. 23 and FIG. 24 illustrate a state in which the carriage 3 is positioned on the furthest +X direction side within the reciprocating range A1. Specifically, the recording apparatus 1 of the present embodiment can perform so-called skew correction for suppressing skewed transport of the medium by repeating transport of the medium being transported in a transport direction and transport of the medium in a direction opposite to the transport direction. At the time of skew correction, the carriage 3 is arranged at the position illustrated in FIG. 23 and FIG. 24. Herein, at the time of screw correction, the switching lever unit 121 rotates as the transport roller 7 rotates. Thus, as illustrated in FIG. 23, the head forming surface 3a and the switching lever unit 121 contact with each other.

The carriage 3 of the present embodiment includes the recording head 4, a medium width sensor 21, a hole shape 22, and the like on the head forming surface 3a. Those are sensitive components that may undergo performance changes or the like due to contact with other components, and hence correspond to non-allowable portions that does not allow contact with the switching lever unit 121. Note that, in the carriage 3 of the present embodiment, as illustrated in FIG. 23, the distal end portion 121a of the switching lever unit 121 is arranged at a position facing the medium width sensor 21. In view of this, in the periphery of the medium width sensor 21 being a non-allowable portion, the carriage 3 of the present embodiment is provided with a guard portion 3b that guards the medium width sensor 21. Further, there is adopted a configuration in which a part of the distal end portion 121a of the switching lever unit 121, which faces the guard portion 3b, is provided with a flat facing surface. Thus, even when the distal end portion 121a contacts with the guard portion 3b, the recording apparatus 1 of the present embodiment can prevent the distal end portion 121a from contacting with the medium width sensor 21 being a non-allowable portion.

Note that the present embodiment adopts a configuration in which the distal end portion 121a of the switching lever unit 121 is arranged at the position facing the medium width sensor 21 being a non-allowable portion. Thus, the periphery of the medium width sensor 21 is provided with the guard portion 3b that guards the medium width sensor 21. However, when there is adopted a configuration in which the distal end portion 121a of the switching lever unit 121 is arranged at a position facing the recording head 4 being a non-allowable portion, the guard portion 3b may be provided in the periphery of the recording head 4. When there is provided a configuration in which the distal end portion 121a of the switching lever unit 121 is arranged at a position facing the hole shape 22 being a non-allowable portion, the guard portion 3b may be provided in the periphery of the hole shape 22.

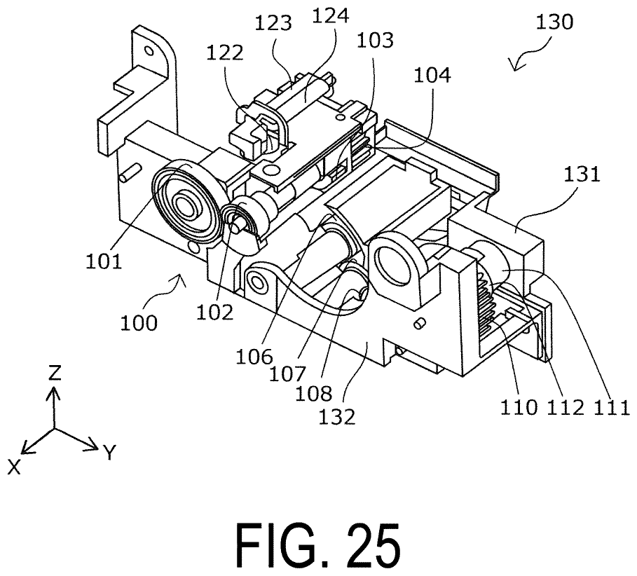

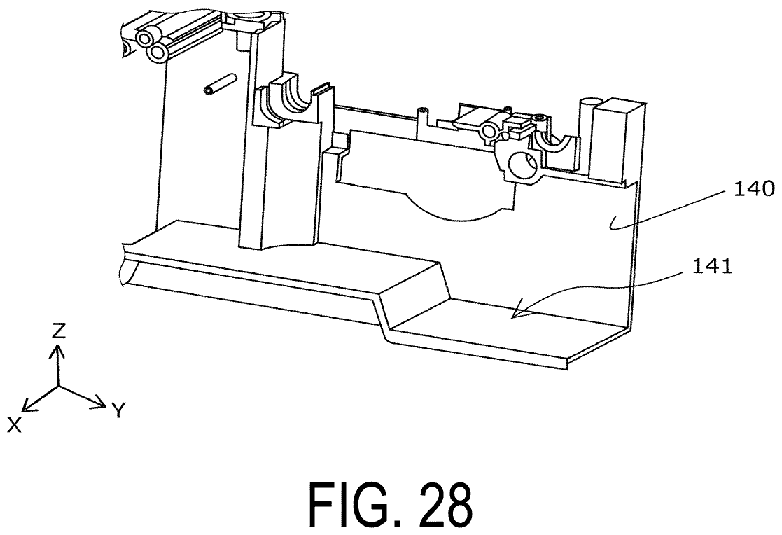

Next, a configuration attaching the power transmission unit 100 is described with reference to FIG. 25 to FIG. 28. As illustrated in FIG. 25 to FIG. 27, the power transmission unit 100 is formed as one unit 130 sandwiched between a first frame 131 including a plurality of toothed gear support portions 131a and a second frame 132 in the X axis direction. Further, the unit 130 is placed on and fixed to a placement portion 141 of a main body frame 140 to which the discharge roller 8 is attached, which is illustrated in FIG. 28.

In other words, the recording apparatus 1 of the present embodiment includes the main body frame 140 to which the discharge roller 8 is attached, and the power transmission unit 100 is provided to the unit 130 that is a separate body from the main body frame 140 and is attachable to and detachable from the main body frame 140. The recording apparatus 1 of the present embodiment is thus configured. Thus, attachment of the power transmission unit 100 into the recording apparatus 1 can be facilitated, and replacement, cleaning, or the like of the power transmission unit 100 can be facilitated.

### Second Embodiment

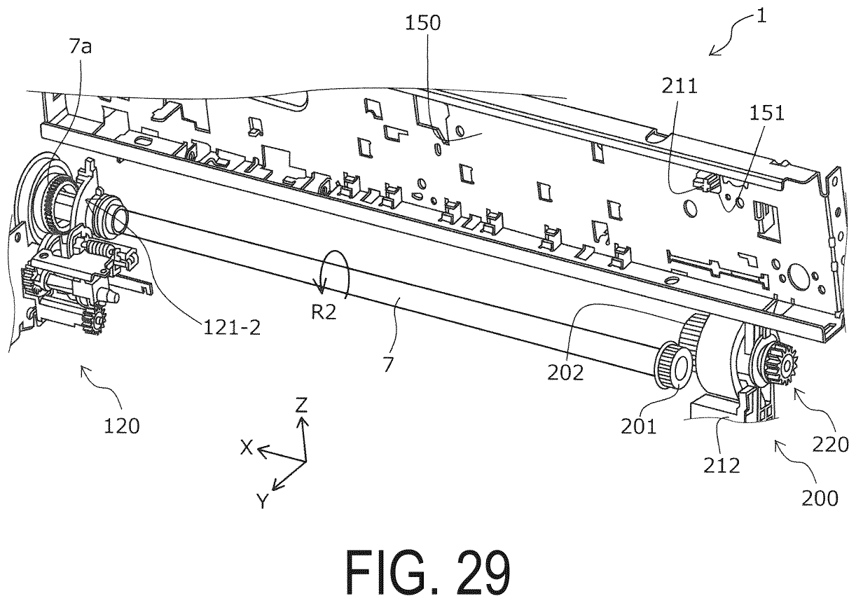

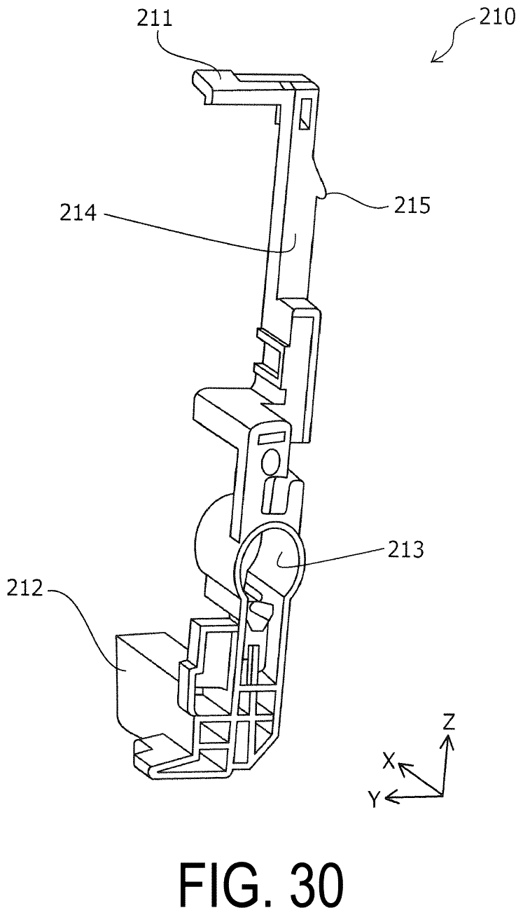

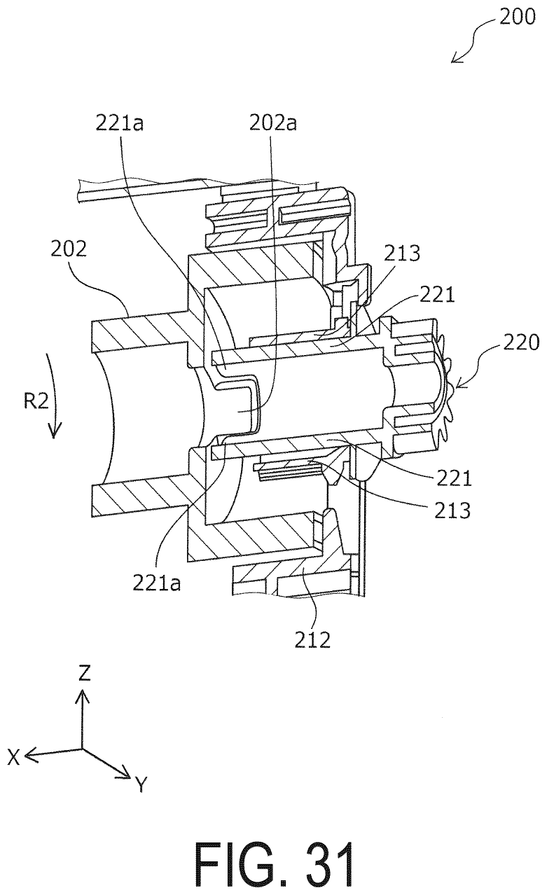

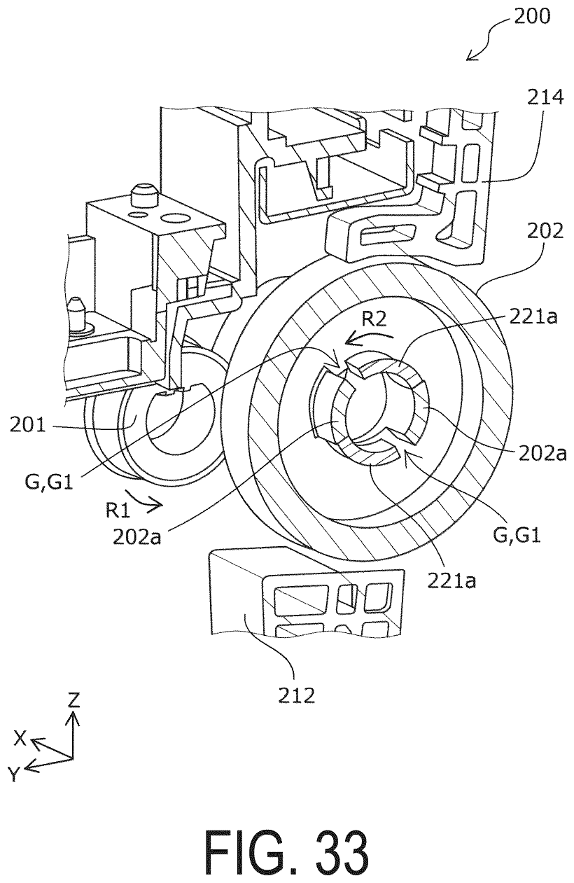

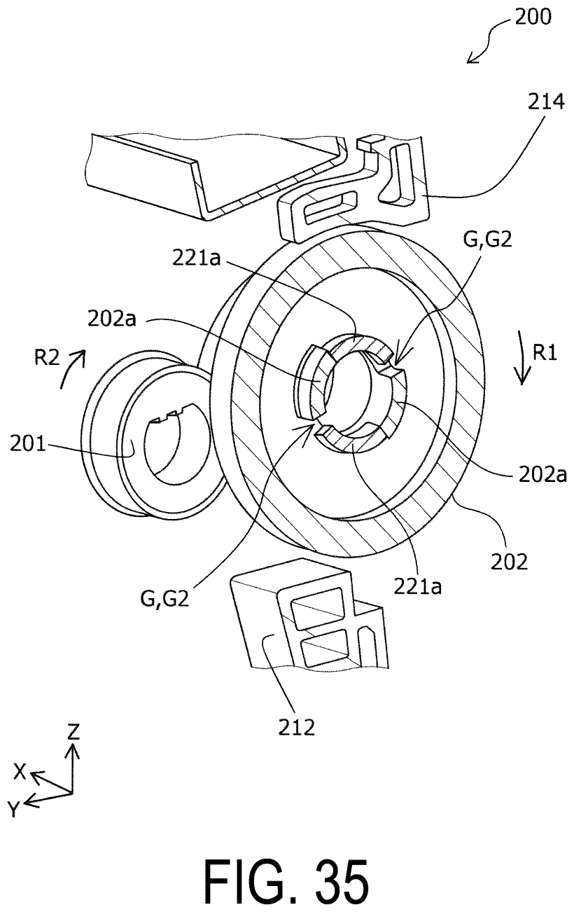

Next, with reference to FIG. 29 to FIG. 36, the recording apparatus 1 of the second embodiment is described. In FIG. 29 to FIG. 36, the components common to those in the first embodiment described above are denoted with the same reference symbols, and the detailed description thereof is omitted. Note that the recording apparatus 1 of the present embodiment is configured similarly to the recording apparatus 1 of the first embodiment, except for the configuration of the switching lever unit and the periphery thereof, and correspondingly, a range in which the switching lever unit rotates from the non-contact position to the contact position. Thus, the configuration illustrated in FIG. 30, FIG. 31, FIG. 33, and FIG. 35 is similar to the configuration of the recording apparatus 1 of the first embodiment, and the recording apparatus 1 of the present embodiment includes features similar to the recording apparatus 1 of the first embodiment, except for the parts described below.

As illustrated in FIG. 29, the recording apparatus 1 of the present embodiment is provided with an auto sheet feeder (ASF) operation switching mechanism 200 on the −X direction side with respect to the power switching mechanism 120. The ASF operation switching mechanism 200 includes the toothed gear 201 that is coupled to the transport roller 7, a toothed gear 202 that is engaged with the toothed gear 201, a friction toothed gear 220 that is engaged with the toothed gear 202, and an ASF trigger lever unit 210 that can rotate in synchronization with the friction toothed gear 220 by a friction force with the friction toothed gear 220.

As illustrated in FIG. 30, the ASF trigger lever unit 210 includes a shaft portion 214, a cylindrical portion 213 formed on the shaft portion 214, an upper end portion 211, and a lower end portion 212. As illustrated in FIG. 31, the cylindrical portion 213 passes through a cylindrical portion 221 of the friction toothed gear 220 while contacting therewith, and the ASF trigger lever unit 210 is configured to rotate in the rotation direction R1 and the rotation direction R2 with the cylindrical portion 213 as a rotational movement shaft as the friction toothed gear 220 rotates.

Further, as illustrated in FIG. 29, the upper end portion 211 is configured to protrude from a hole portion 151 of the frame portion 150 to the +Y direction side. Herein, the frame portion 150 is arranged to face the carriage 3 in the Y axis direction. Further, in a case in which the carriage 3 is positioned on the −X direction side, even when the upper end portion 211 protrudes from the hole portion 151 to the +Y direction side, the upper end portion 211 is arranged to be pressed to the −Y direction side by the carriage 3.

Herein, as illustrated in FIG. 30, the shaft portion 214 of the ASF trigger lever unit 210 is provided with a protrusion portion 215. When the cylindrical portion 213 rotates in the rotation direction R2 together with the cylindrical portion 221, and then the upper end portion 211 protrudes from the hole portion 151 to the +Y direction side, the protrusion portion 215 is away from an ASF operation execution mechanism, which is omitted in illustration, and a state in which the ASF operation execution mechanism can be driven to execute the ASF operation is achieved. Meanwhile, when the upper end portion 211 is pressed in the −Y direction by the carriage 3 or the cylindrical portion 213 rotates in the rotation direction R1 together with the cylindrical portion 221, and then the cylindrical portion 213 does not protrude from the hole portion 151 to the +Y direction side, the protrusion portion 215 is arranged at a position of preventing the ASF operation execution mechanism, which is omitted in illustration, from driving, and a state in which the ASF operation execution mechanism cannot be driven to prevent execution of the ASF operation is achieved.

Note that, as illustrated in FIG. 31, FIG. 33, and FIG. 35, the toothed gear 202 and the friction toothed gear 220 are engaged with each other via two projection portions 220a provided to the toothed gear 202 and two projection portions 221a provided to the friction toothed gear 220. As illustrated in FIG. 33 and FIG. 35, as viewed in the rotation shaft direction of the toothed gear 202 and the friction toothed gear 220, the two projection portions 202a and the two projection portions 221a are engaged with each other via gaps G. Thus, with respect to rotation of the transport roller 7, the toothed gear 201, and the toothed gear 202, rotation of the friction toothed gear 220 and rotating of the ASF trigger lever unit 210 are delayed as a time lag.

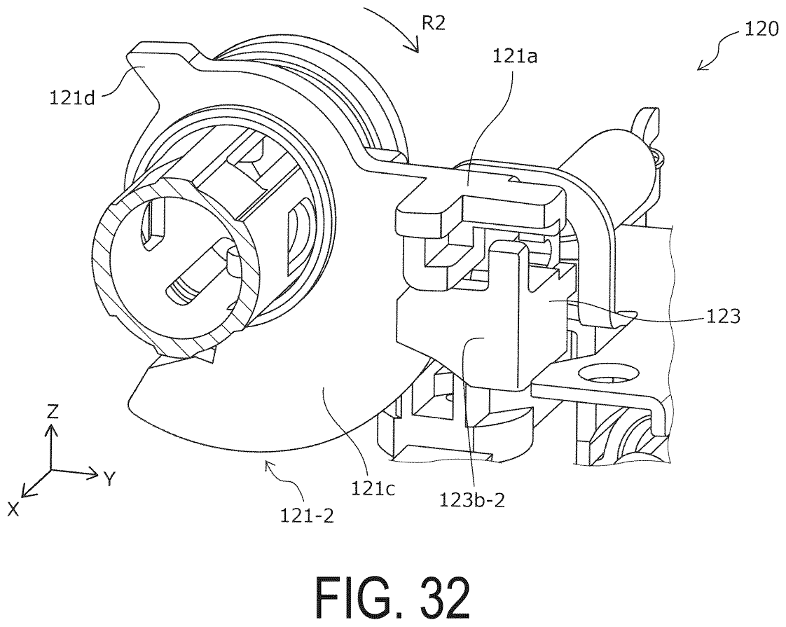

At the time of recording or the like, the recording apparatus 1 of the present embodiment rotates the transport roller 7 in the rotation direction R2 being a forward rotation direction. Then, a switching lever unit 121-2 of the present embodiment rotates in the rotation direction R2, and is at the non-contact position, which is illustrated in FIG. 32. As compared to the switching lever unit 121 of the first embodiment, the switching lever unit 121-2 of the present embodiment includes the distal end portion 121a, but does not include the engaging portion 121b. Instead, there is adopted a configuration in which the switching lever unit 121-2 of the present embodiment includes a disk portion 121c, and the disk portion 121c is engaged with the engaged portion 123b. Note that, due to a difference in shapes between the switching lever unit 121 of the first embodiment and the switching lever unit 121-2 of the present embodiment, the engaged portion 123b of the holding unit 123 of the first embodiment and an engaged portion 123b-2 of the holding unit 123 of the present embodiment have different shapes.

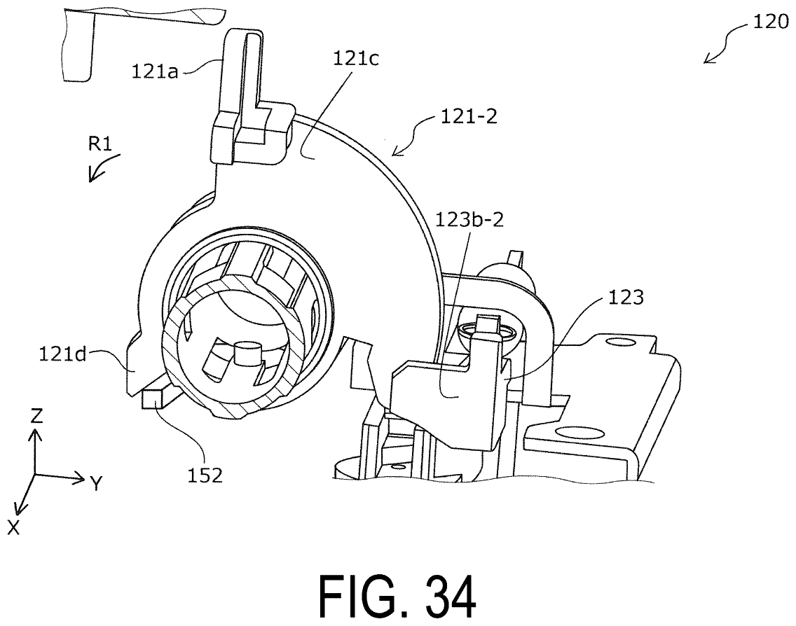

Further, the switching lever unit 121-2 of the present embodiment includes a rotation stopper 121d inside the main body. As illustrated in FIG. 34, there is adopted a configuration in which, even when the transport roller 7 continuously rotates in the rotation direction R1 being a reverse rotation, a rotation stopping engagement portion 152 can stop rotation of the switching lever unit 121-2 in the rotation direction R1. Herein, when the switching lever unit 121-2 of the recording apparatus 1 of the present embodiment is compared with the switching lever unit 121 of the recording apparatus 1 of the first embodiment, a rotation amount of the switching lever unit 121-2 from the non-contact position to the contact position is larger. Note that, the position of the switching lever unit 121-2 illustrated in FIG. 34 corresponds to a first contact position of the contact positions. Further, the state illustrated in FIG. 34 correspond to the state illustrated in FIG. 33. In other words, when the switching lever unit 121-2 is at the first contact position, the two projection portions 202a and the two projection portions 221a form a gap G1 of the gaps G, and the ASF trigger lever unit 210 is in a state in which the upper end portion 211 does not protrude from the hole portion 151 to the +Y direction side.

Note that, as described above, the ASF trigger lever unit 210 includes the lower end portion 212. The lower end portion 212 functions as a weight, and is about to rotate the rotation direction R2 with the cylindrical portion 213 as a rotational movement shaft. Thus, in a case in which the state illustrated in FIG. 33 remains, when the recording apparatus 1 oscillates, for example, the ASF trigger lever unit 210 rotates in the rotation direction R2 by an amount corresponding to the gap G1 due to an own weight, and the upper end portion 211 is to protrude from the hole portion 151 to the +Y direction side. In a case in which the carriage 3 moves from the position of not facing the hole portion 151 to the position of facing the hole portion 151, when the upper end portion 211 protrudes from the hole portion 151 to the +Y direction side, the carriage 3 may collide with the upper end portion 211, and an error may be caused.

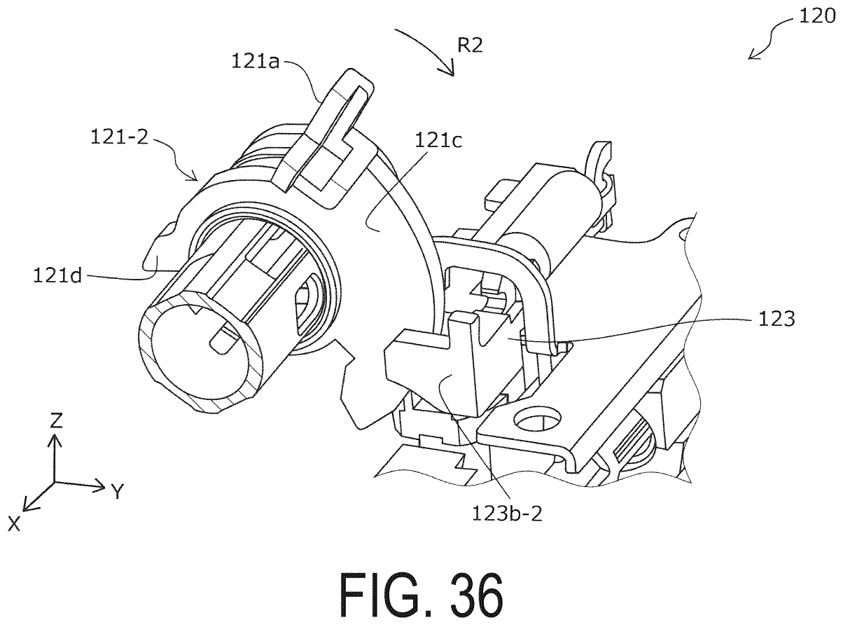

In view of this, the recording apparatus 1 of the present embodiment is shifted from the state illustrated in FIG. 33 and the state illustrated in FIG. 34 to the state illustrated in FIG. 35 and the state illustrated in FIG. 36 by rotating the transport roller 7 in the rotation direction R2 by a small amount. Then, as illustrated in FIG. 35, the two projection portions 202a and the two projection portions 221a form a gap G2 on a side opposite to the gap G1, and the ASF trigger lever unit 210 cannot rotate in the rotation direction R2 by an own weight. Further, as illustrated in FIG. 36, as the transport roller 7 rotates in the rotation direction R2, the position of the switching lever unit 121-2 is a second contact position obtained by rotation from the first contact position by a smaller amount to the rotation direction R1 side.

In this manner, in the recording apparatus 1 of the present embodiment, a rotation amount of the switching lever unit 121-2 from the non-contact position to the contact position is larger than the switching lever unit 121 of the recording apparatus 1 of the first embodiment. Further, in a case in which the switching lever unit 121-2 is not only at the first contact position but also at the second contact position, when the carriage 3 moves in the +X direction, the disk portion 121c is configured to contact with the carriage 3. The recording apparatus 1 of the present embodiment is thus configured. Therefore, when the upper end portion 211 protrudes from the hole portion 151 to the +Y direction side at timing unexpected for a user, a risk of an error caused by collision of the carriage 3 against the upper end portion 211, a movement operation mistake or an erroneous movement of the medium reception tray 5, and the like can be suppressed without increasing the size of the apparatus.

Herein, in summary, the switching lever unit 121-2 of the present embodiment, which is at the contact position, can be arranged at the first contact position and the second contact position for contacting with the carriage 3 as the carriage 3 reciprocates. Thus, in the recording apparatus 1 of the present embodiment, the arrangement of the switching lever unit 121-2 can be changed as required while maintaining the switching lever unit 121-2 at the contact position.

Further, the switching lever unit 121-2 of the present embodiment can be arranged at the first contact position and the second contact position by rotating. Thus, in the recording apparatus 1 of the present embodiment, the arrangement of the switching lever unit 121-2 can be changed easily while maintaining the switching lever unit 121-2 at the contact position.

Further, the switching lever unit 121-2 of the present embodiment includes the disk portion 121c being a contactable portion that is extended in the rotation direction and contacts with the carriage 3. The recording apparatus 1 of the present embodiment is thus configured. Thus, in a case in which the switching lever unit 121-2 is arranged at the first contact position or the second contact position, even when an error or the like is caused at the arrangement position, the switching lever 121-2 can suitably be remained at the contact position.

The present disclosure is not limited to the above-described embodiments, and can be realized in various configurations without departing from the spirit of the present disclosure. Appropriate replacements or combinations may be made to the technical features in the present embodiments which correspond to the technical features in the aspects described in the SUMMARY section to solve some or all of the problems described above or to achieve some or all of the advantageous effects described above. Further, when the technical characteristics are not described as being essential in the present specification, the technical characteristics can be deleted as appropriate.

What is claimed is:

1. A recording apparatus comprising:
a recording head attached to a carriage and configured to perform recording on a medium, the carriage being configured to reciprocate;
a discharge roller configured to discharge the medium on which the recording was performed;
a medium reception tray configured to receive the medium discharged by the discharge roller, the medium reception tray being configured to be in a first state and in a second state in which the medium reception tray is displaced from a position in the first state in a discharge direction of the medium;
a motor being a power source of the discharge roller;
a power transmission unit configured to be in a power transmission state in which power of the motor is transmitted from the motor to the medium reception tray and a power non-transmission state in which power of the motor from the motor is not transmitted to the medium reception tray; and
a switching lever unit configured to switch between the power non-transmission state and the power transmission state, wherein
the switching lever unit
rotates between a contact position at which the switching lever unit is configured to come into contact with the carriage as the carriage reciprocates and a non-contact position at which the switching lever unit does not come into contact with the carriage even when the carriage moves, and
when the switching lever unit is at the contact position, switches between the power non-transmission state and the power transmission state by sliding in contact with the carriage as the carriage reciprocates.

2. A recording apparatus according to claim 1, wherein
when the switching lever unit is at the contact position, at least a distal portion of the switching lever unit enters a reciprocating range of the carriage, and
when the switching lever unit is at the non-contact position, the distal end portion exits from the reciprocating range of the carriage.

3. A recording apparatus according to claim 2, wherein
the carriage is provided with a non-allowable portion being not allowed to make contact with the switching lever unit,
a guard portion configured to guard the non-allowable portion is provided around the non-allowable portion, and
the distal end portion is provided with a facing surface facing the guard portion.

4. A recording apparatus according to claim 1, wherein
the power transmission unit includes a lock component configured to prevent rotation of a gear when the power transmission unit is in the power non-transmission state and a transmission component configured to transmit power of the motor when the power transmission unit is in the power transmission state, and
the switching lever unit switches coupling of the lock component and the transmission component in the power transmission unit by sliding in contact with the carriage.

5. A recording apparatus according to claim 4, wherein
the power transmission unit switches coupling from the lock component to the transmission component by applying an external load in a direction in which the switching lever unit slides in contact with the carriage.

6. A recording apparatus according to claim 4, wherein
the power transmission unit includes a cam having a cam surface and a holding unit configured to hold the lock component and the transmission component and including a pin to be arranged on the cam surface, and
the power transmission unit shifts between the power non-transmission state and the power transmission state when the pin moves on the cam surface.

7. A recording apparatus according to claim 6, wherein
the cam surface is provided with a flat surface portion at which the pin is positioned when the power transmission unit is in the power non-transmission state, and a pin holding portion configured to hold the pin when the power transmission unit is in the power transmission state.

8. A recording apparatus according to claim 1, comprising:
a frame to which the discharge roller is attached, wherein
the power transmission unit is provided to a unit being a separate body from the frame and being configured to be attached to and detached from the frame.

9. A recording apparatus according to claim 1, wherein
the switching lever unit located at the contact position is configured to be arranged at a first contact position and second contact position where the switching lever unit and the carriage are contactable as the carriage reciprocates.

10. A recording apparatus according to claim 9, wherein
the switching lever unit is configured to be arranged at the first contact position and the second contact position by rotating.

11. A recording apparatus according to claim 10, wherein
the switching lever unit includes a contactable portion extending in a rotating direction and being contactable with the carriage.
